(19) United States
(12) Patent Application Publication
(10) Pub. No.: US 2004/0197759 A1
(43) Pub. Date: Oct. 7, 2004

(54) System, method and computer program product for generating a customized course curriculum

(76) Inventor: Kevin Michael Olson, Sunnyvale, CA (US)

Correspondence Address: SQUIRE, SANDERS & DEMPSEY L.L.P, 600 HANSEN WAY, PALO ALTO, CA, 94304-1043, US

(21) Appl. No.: 10/405,449

(22) Filed: Apr. 2, 2003

(51) Int. Cl. G09B 3/00

(52) U.S. Cl. 434/322

(57) ABSTRACT

A system, method and computer program product are disclosed for generating a customized course curriculum. In accordance with one embodiment, a plurality of questions are presented to an end user. Answers to the questions received from the end user are analyzed to identify one or more skills and to rank the identified skills. Each skill has one or more courses associated therewith. A list of the courses associated with the identified skills is generated with courses ordered in the list based on the ranking of their associated identified skills. The list of courses is then presented to the end user.

### BACKGROUND

This invention relates to education and training, and more particularly, relates to network based education and training.

Increasing the knowledge level of an entire workforce may be a key to continued success in an organization. A factor in transferring knowledge is understanding what skills a member of the organization (such as, e.g., an employee) needs to be effective in their job. However, in the past, personalizing education and training for an employee was often laborious and time consuming with the hit-or-miss results in identifying programs or courses best tailored for enhancing the skills needed by the employee in their job role/function.

### SUMMARY

A system, method and computer program product are disclosed for generating a customized course curriculum. In accordance with one embodiment, a plurality of questions are presented to an end user. Answers to the questions received from the end user are analyzed to identify one or more skills and to rank the identified skills. Each skill has one or more courses associated therewith. A list of the courses associated with the identified skills is generated with courses ordered in the list based on the ranking of their associated identified skills. The list of courses is then presented to the end user.

In an embodiment of the present invention, the presenting of the plurality of questions to the end user may include presenting a set of generalized questions to the end user with the answers by the end user to the set of generalized questions being analyzed to identify sets of skills to the end user. In such an embodiment, each of the identified sets of skills may be associated with a category of skills, and wherein the identified sets of skills are presented to the end user based on the associated category of skills.

In one embodiment, the end user may be presented with a plurality of questions relating to the skills in the identified sets of skills to identify skills to the end user in the identified sets of skills and to estimate a degree of relevance to the end user for each identified skill. In such an embodiment, the end user may be presented with a list of the skills in the set of skills for each identified set of skills, and be queried to identify which of the skills in the set of skills are of relevance to the end user. In a further embodiment, for each identified skill, the questions presented to the end user may include: a query about the importance of the skill to the end user, a query about the frequency the end user uses the skill, and a query about whether the end user is interested in learning more about the identified skill.

In an additional embodiment, the analysis of the answers to the questions received from the end user for each identified skill may include assigning a value to the answer to each query, and calculating a total value for the identified skill from the sum of assigned values of the queries presented to the end user about the identified skill. The identified skills may then be ranked with respect to one another based on the total point values of the identified skills.

As another option, for each identified skill, the end user may be presented with a plurality of questions relating to one or more aspects of the identified skill to estimate a degree of relevance to the end user for each identified skill. In such an embodiment, the questions presented to the end user for each aspect of the identified skill may include: a query about the importance of the aspect of the identified skill to the end user, and a query about whether the end user is interested in learning more about the aspect of the identified skill. As a further option, the analysis of the answers to the questions received from the end user may include (for each aspect of the identified skill) assigning a value to the aspect based on the answers by the end user to the two queries for the aspect, calculating an total aspect value for the identified skill based on the sum of the assigned values of the aspects for the identified skill, and then adding the total aspect value to a total point value of the identified skill. In such an embodiment, the identified skills may be ranked in part with respect to one another based on the total values of the identified skills.

In another embodiment, information about one or more aspects of a skill may be provided during the presenting of the plurality of questions relating to the skills in the identified sets of skills. In yet a further embodiment, the progress of the end user answering the presented questions may be tracked so that a status report may be generated that indicate the progress of the end user in answering the presented questions. In yet another embodiment, information about one or more aspects of a skill may be presented during the presentation of the plurality of questions to the end user.

In one embodiment, the end user may be permitted to selectively obtain information about at least one of the courses from the list of courses. In an additional embodiment, each course may have associated therewith a duration of time for completing the course. In such an embodiment, information about the duration of time for completing the course may be presented to the end user with the list of courses. An even another embodiment, the end user may be permitted to select courses from the list of courses. As a further option, at least one of the selected courses may then presented to the end user. Optionally, the progress of the end user in completing the presented course may be monitored and a report about the progress of the end user in completing the present course may be generated based on the monitoring. As a further option, a list of the courses selected by the end user may also be presented to an authorized second end user with this authorized second end user being permitted to approve one or more of the selected courses, and/or add one or more additional courses to the list of selected courses. In one embodiment, the courses may include teachings related to the identified skills. In another embodiment, at least courses may be analyzed to identify skills associated with subject matter of the course. One or more questions relating to the skills identified in the analyzed courses may then be generated and presented to the end user.

### BRIEF DESCRIPTION OF THE DRAWINGS

FIG. 1 is a flowchart of a process for generating a customized course curriculum in accordance with an embodiment of the present invention;

FIG. 2 is a schematic block diagram of an exemplary architecture for implementing a process for generating a customized course curriculum in accordance with an embodiment of the present invention;

FIG. 3 is a schematic diagram of an illustrative structural overview for a career track assistant application in accordance with an embodiment of the present invention;

FIG. 4 is a schematic diagram illustrating the relationship between questions, skills, skill categories, skill suites, skills, skill objects and courses utilized by a curriculum planning and managing application in accordance with an embodiment of the present invention;

FIG. 5 is a schematic representation of an exemplary introductory display for a first set of questions that generally relate to the end user's current job position during a session with a career track assistant application in accordance with an embodiment of the present invention;

FIG. 6 is a schematic representation of an exemplary display for presenting the first set of questions that generally relate to the end user's current job position during a session with a career track assistant application in accordance with an embodiment of the present invention;

FIG. 7 is schematic representation of another exemplary display for presenting the first set of questions that generally relate to the end user's current job position during a session with a career track assistant application in accordance with an embodiment of the present invention;

FIG. 8 is a schematic representation of an exemplary status display for a second set of questions for identifying and ranking skills relating to the end user's current job position during a session with a career track assistant application in accordance with an embodiment of the present invention;

FIG. 9 is a schematic representation of an exemplary display for presenting a second set of questions for identifying and ranking skills or functions relating to the end user's current job position during a session with a career track assistant application in accordance with an embodiment of the present invention;

FIG. 10 is a schematic representation of an exemplary status display for a third set of questions for defining skills and responsibilities relating to the end user's current job position during a session with a career track assistant application in accordance with an embodiment of the present invention;

FIG. 11 is a schematic representation of an exemplary display for presenting user-selectable skill object selections to an end user of a third set of questions for defining skills and responsibilities relating to the end user's current job position during a session with a career track assistant application in accordance with an embodiment of the present invention;

FIG. 12 is a schematic representation of an exemplary display as an alternative option to the display set forth in FIG. 9 for presenting a second set of questions for identifying and ranking skills or functions relating to the end user's current job position during a session with a career track assistant application in accordance with an embodiment of the present invention;

FIG. 13 is a schematic representation of an exemplary details display presented to an end user by a career planning and managing application upon selection of a details link of the display illustrated in FIG. 12;

FIG. 14 is a schematic representation of an exemplary skills status display presented to an end user by a career planning and managing application upon selection of a view status link of the display illustrated in FIG. 12;

FIG. 15 is a schematic representation of an exemplary specify details display presented to an end user by a career planning and managing application upon selection of a specify details link of the display illustrated in FIG. 12 in accordance with an embodiment of the present invention;

FIG. 16 is a schematic diagram of an exemplary display for presenting a personal learning plan to an end user in accordance with an embodiment of the present invention;

FIG. 17 is a schematic diagram of an exemplary display for presenting a training hours report in accordance with an embodiment of the present invention;

FIG. 18 is a schematic diagram of an exemplary main menu display from which an authorized end user may generate and review reports about an individual end user or an aggregated group of end users utilizing the career planning and managing application in accordance with an embodiment of the present invention;

FIG. 19 is a schematic diagram of an exemplary individual reports menu display accessible upon selection of the individual reports link in accordance with an embodiment of the present invention;

FIG. 20 is a schematic diagram of an exemplary display for generating a personal learning plan in accordance with an embodiment of the present invention;

FIG. 21 is a schematic diagram of an exemplary display for presenting an individual personal learning plan in accordance with an embodiment of the present invention;

FIG. 22 is a schematic diagram of an exemplary display for presenting a top skills list in accordance with an embodiment of the present invention;

FIG. 23 is a schematic representation of an exemplary display for a training hours report approval status report in accordance with an embodiment of the present invention;

FIG. 24 is a schematic representation of an exemplary display for a course approval status report in accordance with an embodiment of the present invention;

FIG. 25 is a schematic diagram of an exemplary display for selecting parameters for generating aggregate reports in accordance with an embodiment of the present invention;

FIG. 26 is a schematic diagram of an exemplary display for an aggregate personal learning plan report based on selection from FIG. 25 in accordance with an embodiment of the present invention;

FIG. 27 is a schematic diagram of an exemplary display for generating reports by an end user having administrative powers with the curriculum planning and managing application in accordance with an embodiment of the present invention;

FIG. 28 is a schematic representation of a display for generating aggregate reports by an end user with administrative authority in accordance with an embodiment of the present invention;

FIG. 29 is a flowchart of an exemplary detailed process for generating a customized course curriculum utilizing a curriculum planning and managing application in accordance with an embodiment of the present invention;

FIG. 30 is a table of exemplary answer values used by the career planning and managing application to score a skill in accordance with an exemplary embodiment of the present invention;

FIG. 31 is a schematic block diagram of reports that may be generated utilizing a career planning and managing application in accordance with an embodiment of the present invention;

FIG. 32 is a schematic diagram of an exemplary individual personal learning plan report in accordance with an embodiment of the present invention;

FIG. 33 is a schematic diagram of an exemplary individual top skills report in accordance with an embodiment of the present invention;

FIG. 34 is a schematic diagram of an exemplary aggregate top personal learning plan report in accordance with an embodiment of the present invention;

FIG. 35 is a schematic diagram of an exemplary aggregate top skills report in accordance with an embodiment of the present invention;

FIG. 36 is a schematic diagram of an illustrative network system with a plurality of components in accordance with an embodiment of the present invention; and

FIG. 37 is a schematic diagram of a representative hardware environment in accordance with an embodiment of the present invention.

### DETAILED DESCRIPTION

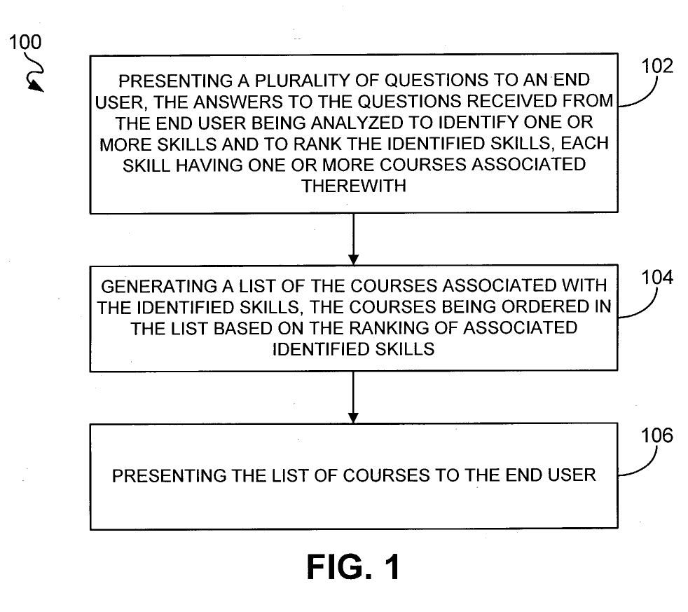

Embodiments of a system, method and computer program product are disclosed for generating a customized course curriculum. FIG. 1 is a flowchart of a process for generating a customized course curriculum in accordance with an embodiment of the present invention. In operation 102, a plurality of questions are presented to an end user. Answers to the questions received from the end user are analyzed to identify one or more skills and to rank the identified skills. Each skill also has one or more courses associated therewith. In operation 104, a list of the courses associated with the identified skills is generated with courses ordered in the list based on the ranking of their associated identified skills. The list of courses is then presented to the end user in operation 106.

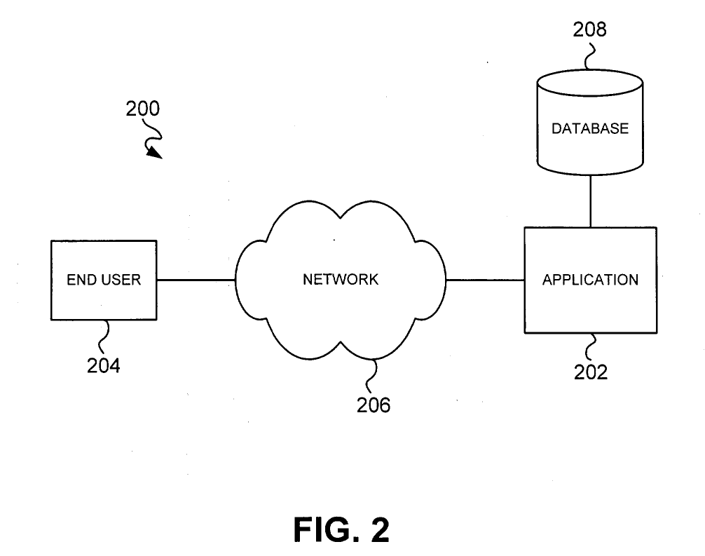

FIG. 2 is a schematic block diagram of an exemplary architecture 200 for implementing a process for generating a customized course curriculum in accordance with an embodiment of the present invention. The architecture 200 may include a curriculum planning and managing application 202 (also referred to herein as the “career track assistant application,” the “CTA” or as the “application”) for presenting a plurality of questions to an end user 204 in communication with the curriculum planning and managing application via a network 206. In accordance with one embodiment, the may reside on a computer coupled to the network. Similarly, the end user may utilize a computer to communicate via the network with the curriculum planning and managing application. The end user's computer may also include a display or other type of user interface (e.g., other audio, tactile, or visual interfaces) capable of displaying the presented questions and receiving inputs from the end user for answering the presented questions.

The end user's answers to the questions may also be returned to the curriculum planning and managing application via the network for analysis by the curriculum planning and managing application to identify one or more skills relevant or of interest to the end user and to rank the identified skills in order of an estimated importance to the end user. Each skill has one or more courses associated therewith. Based on the analysis, the curriculum planning and managing application may then generate an ordered list of the courses associated with the identified skills (also referred to herein as a “personal learning plan”) for presenting to at least the end user. As an option, the courses may be ordered in the list based on the ranking of their respective associated identified skills. The curriculum planning and managing application may then present the ordered list of courses to the end user as a personal learning plan via the network. The courses in the list may include courses that have teachings relating to aspects of the identified skills. In one embodiment, the list of courses may be presented to the end user via a display device such as a monitor coupled to a computer in communication with the network through which the end user is in communication with the application.

As illustrated in FIG. 2, the curriculum planning and managing application may also be in communication with a database 208 in which the questions, information about the skills, courses, association therebetween, and other information may be stored and retrieved by the curriculum planning and managing application.

In one embodiment, the questions presented to the end user by the curriculum planning and managing application may include a set of generalized questions. The answers returned by the end user may be analyzed by the curriculum planning and managing application to identify sets of skills (also referred to herein as “skill sets” or “skill suites”) that may be relevant or of some interest to the end user. It should be noted, that the association between skills and sets of skills may also be stored in the database. In one embodiment, at least some of the generalized questions may simply require “yes” or “no” answers from the end user while others may require additional follow up question(s) for the end user to answer in follow up to providing a “yes” answer (or in some cases a “no” answer).

Each of the identified sets of skills may be associated with a corresponding category of skills (also referred herein as a “skill category”). In such an embodiment, the identified sets of skills may be presented to the end user based on their associated category of skills. The association between skills, sets of skills, and categories of skills may all be stored in the database. The questions presented to the end user may also include a plurality of questions that relate to the skills in the identified sets of skills determined to be potentially relevant or of potential interest to the end user. Like the other questions, these questions may be stored in and retrieved from the database. These questions may also be utilized by the curriculum planning and managing application to further identify the relevance or interest by the end user in the identified sets of skills and to help estimate and/or identify the degree of relevance or interest to the end user for each of the identified skills.

The curriculum planning and managing application may also present the end user with a list of the skills in each identified set of skills and queried (via the network) to identify which of the skills in the set of skills are of relevance or interest to the end user. In one embodiment, the questions for each identified skill may include: a first query about the importance of the identified skill to the end user (e.g., a query as to the importance of the identified skill to the end user's job role/job function), a second query about the frequency the end user uses the identified skill (e.g., the end user's frequency of use for the identified skill), and/or a third query asking/about whether the end user is interested in learning more about the identified skill (e.g., the end user's interest in learning more about the identified skill). Like the other answers, the answers to these queries may be stored in the database.

The analysis conductor by the curriculum planning and managing application on the answers received from the end user to the questions for each identified skill may include assigning a point value to the answer to each query presented to the end user about the identified skill and calculating a total point value for the identified skill from the sum of assigned point values of all of the queries presented to the end user about the identified skill. The curriculum planning and managing application may then rank the identified skills with respect to one another based on the calculated total point values of the identified skills. In one embodiment, the higher the total point value of a skill, the higher it is ranked. In this manner, the skill with the highest total point value is the most highly or highest ranked skill and the skill with the lower total point value is the most lowly or lowest ranked skill with all other skills being ranked in between according to their total point value.

In an exemplary implementation of such an embodiment, the point values may be assigned as follows. For the first query for each skill, the higher the point value may be assigned thereto based on the more important the identified skill is to the end user. For the second query for each skill, the higher the point value may be assigned thereto based on how high of frequency the end user uses the identified skill. For the third question for each skill, the higher the point value may be assigned thereto based on the greater interest in learning more about the identified skill indicated by the end user. In such an exemplary implementation, the courses may be ordered in the ordered list based on the total point value of the associated skill, with the course associated with the skill having the highest total point value being ranked highest in the ordered list (i.e., the most highly recommended course) and the course associated with the skill having the lowest total point value being ranked lowest in the ordered list (i.e., the least recommended course).

For each identified skill, the curriculum planning and managing application may also present the end user with a plurality of questions relating to one or more aspects of the identified skill to further estimate and/or identify the degree of relevance and/or interest of the end user for each identified skill. For each aspect of the identified skill in such an embodiment, the questions presented to the end user about the particular aspect may include, for example: a query about the importance of the aspect of the identified skill to the end user (e.g., a query as to the importance of the aspect of the identified skill to the end user's job role/job function), and a query asking about whether the end user is interested in learning more about the aspect of the identified skill (e.g., the end user's interest in learning more about the aspect of the identified skill). In such an embodiment, the analysis of the answers to the questions for each aspect of the identified skill received from the end user may include, assigning a point value to the aspect based on the answers by the end user to the two queries for the aspect presented to the end user, calculating an total aspect point value for the identified skill based on the sum of the assigned point values of the aspects for the identified skill, and then adding the total aspect point value to a total point value of the identified skill. The identified skills may thus be ranked in part with respect to one another based on the total point values of the identified skills as previously described.

In one embodiment, information about one or more aspects of a skill may be provided during the presenting of the plurality of questions relating to the skills in the identified sets of skills. In such an embodiment, the information about the one or more aspects of the skill may be provided upon selection of a link positioned adjacent a question relating to the particular skill.

The curriculum planning and managing application may also track the progress of the end user in completing the answering of the presented questions. Based on the tracking, the curriculum planning and managing application may generate a status report indicating the progress of the end user in completing the answering of the presented questions so that the end user can track their progress through a session with the curriculum planning and managing application. In such an embodiment, a status report may even be provided to an end user upon resuming a previously started session and/or during the presenting of questions to the end user.

The curriculum planning and managing application may also providing information about one or more aspects of a skill to the end user via the network during the presenting of the questions to the end user. For instance, the information about the one or more aspects of the skill may be provided upon selection by the end user of a link presented adjacent to a question relating to the particular skill in question. In an exemplary embodiment, this information may be provided in a pop up type of window. Like other information provided to the end user, the information about the aspects of the skills may also be stored in and retrieved from the database by the curriculum planning and managing application upon receipt via the network of an indication that the end user is requesting to access such information.

The end user may also be permitted to selectively obtain from the curriculum planning and managing application further detailed information about at least one of the courses (e.g., detailed description of the course, a syllabus for the course etc., information about the provider of the course, etc.) from the presented ordered list of courses via the network. As an option, each course may have associated therewith a duration of time (i.e., course duration) for completing the course. Information about the duration of time for completing the course may be presented to the end user with the ordered list of courses. The course duration information may also be stored in and retrieved from the, database.

The curriculum planning and managing application may also permit the end user to select or selectively request courses from the ordered list of courses via the network. The curriculum planning and managing application may also be utilized to present the selected courses to the end user so that the end user may view, take or participate in the course via the network. for presentment to the end user via the network. The end user's selection of courses and the materials for the course (i.e., course materials) may be stored in and retrieved from the database by the curriculum planning and managing application.

The curriculum planning and managing application may monitor the progress of the end user in completing the presented course(s). From information obtained from this monitoring, the curriculum planning and managing application may generate a report about the progress of the end user in completing the present course(s). This report may presented to a variety of end users such as, for example the end user taking the course (e.g., an employee end user), a manager end user, and/or an administrator end user.

Via the network, the curriculum planning and managing application may also present a report with a list of the courses selected by the end user to an authorized second end user (i.e., a manager end user having managerial responsibilities over the end user) and permit the second end user to approve one or more of the selected courses from the list of selected courses, and/or add one or more additional courses to the list of selected courses. As a further option, the authorized second end user may also be permitted to generate reports relating to one or more other end users (i.e., generate aggregate reports) using the curriculum planning and managing application. Some illustrative generated aggregate reports may include: aggregate personal learning plan reports, aggregate top skills reports, aggregate training hours reports, an aggregate course approval status report n and an aggregate user status report.

In one embodiment, the association of skills and skill aspects to a new course may be accomplished as follows. Upon receiving information about a course (e.g., a new or additional course), the curriculum planning and managing application may analyze the course to identify skills associated with subject matter of the course (i.e., the subjects or skills covered by the course). Based on the analysis, one or more questions relating to the skills may be generated. The identified skills, generated questions and their associations with the new course may be stored in the databases. The generated questions may then be included in the questions presented to the end user to determine whether the new course should be included in the list of courses presented to the end user.

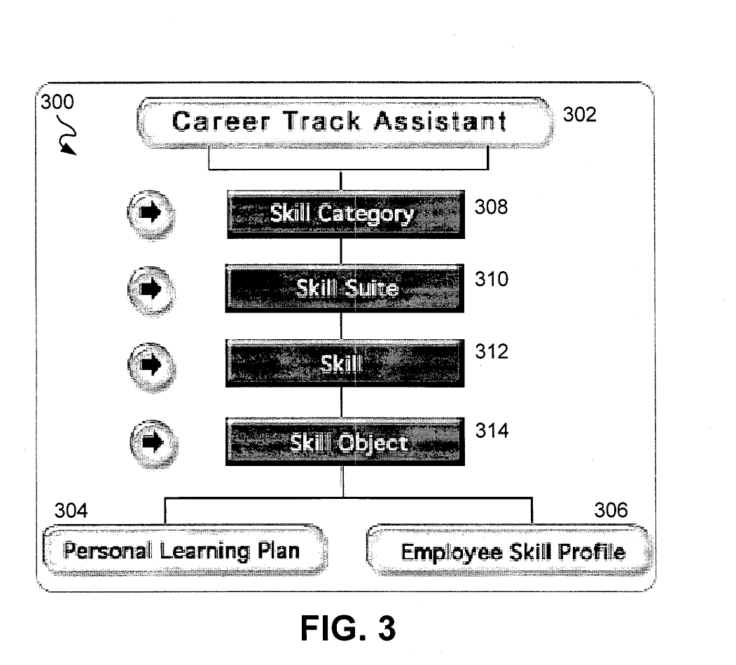

FIG. 3 is a schematic diagram of an illustrative structural overview 300 for a career track assistant application in accordance with an embodiment of the present invention. Increasing the knowledge level of an entire workforce may be a key to ongoing competitive advantage in today's marketplace. Implementations of the career track assistant application 302 may empower companies to automate the identification of skills employees possess and skills employees need in order to improve production, service, and overall performance. An end result of the career track assistant application may a personal learning plan 304 and/or skill profile 306 for each end user. In accordance with one embodiment, the career track assistant application 302 may organize skills into skill categories 308, skill suites 310, skill s 312, and skill objects 314.

Skill categories 308 represent the highest level at which skills are organized. For example, Skill categories may include management, sales, and operating systems skill categories. Skill categories are comprised of one or more skill suites 310. A skill suite Skill 310 may be comprised of one or more skills 312. For example, the exemplary management skill category may be comprised of a project management skill suites. A skill suite 310 may comprise one or more skills 314 and in an preferred embodiment may comprise two to fifteen skills. Skills 314 may be comprised of one or more skill objects 316. For example, a developing and managing the scope of a project skill may be one of many skills comprising the exemplary project management skill suite. A skill 314 may comprise one or more skill objects 316 and, in a preferred embodiment, may comprise between five and fifteen skill objects. Skill objects 316 may represent a granular unit of a measurable skill 314. For example, an identifying the process of scope verification skill object may be one of many skill objects 316 associated with the exemplary developing and managing the scope of a project skill.

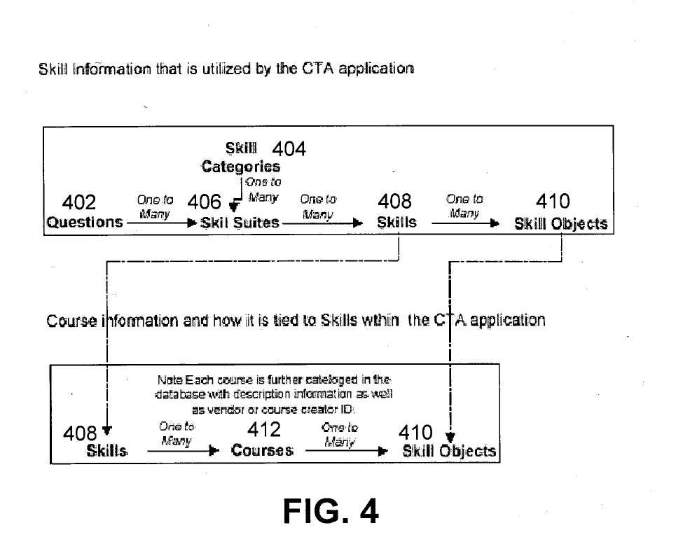

FIG. 4 is a schematic diagram illustrating the relationship between questions, skills, skill categories, skill suites, skills, skill objects and courses utilized by a curriculum planning and managing application in accordance with an embodiment of the present invention. Questions 402 presented to an end user by the curriculum planning and managing application are used to identify one or more skill categories 404, skill suites 406, skills 408 and skill objects 410. Skills 408 are tied to (i.e., relate to) one or more particular courses 412 which in turn contain information relating to one or more of the skill objects 410.

General End User

The career track assistant application may provide a standardized process of identifying relevant skills and competencies for each and every end user (e.g., each employee of a business). In a session with the career track assistant application, an end user may work through a database of skill objects in an effort to highlight not only an individual's job responsibilities but also generate a personal learning plan tailored to the particular end user, group and/or department of the business. The career track assistant application may be adaptive to the end-user's experience and based on the end user's responses to pre-formatted questions with only the relevant skills and competencies being displayed at each stage of the session for the end-user to even further define and rank. As an option, the career track assistant may provide a book marking features to permit an end user to resume a previously started but not-completed session.

The following portion of the description and accompanying figures illustrate various displays presented to an end user during a session for generating a personalized learning plan utilizing a career track assistant application. In general, the career track assistant application generates a personalized learning plan for the end user by obtaining answers from the end user to a series of questions posed to the end user about the end user's job functions and skills. The series of questions posed to the end user includes a first set of questions generally relating to the end user's current job position, a second set of questions for identifying and ranking skills relating to the end user's current job position, and a third set of questions for defining skills and responsibilities relating to the end user's current job position.

In a preferred embodiment, an end user may begin a session by logging into the career track assistant application via a network connection using a user name and password associated with the end user. The user name and password may be selected by the end user or be provided to the end user by a service hosting the career track assistant application via an email message sent via a network. After logging into the career track assistant application, a main menu may be displayed to the end user by which the end user may select their next action. The main menu display may include a selection or link for beginning a session with the career track assistant application or for resuming a previously begun session that was prematurely ended before completion (i.e., before the series of questions have been completely answered). As an option, a user agreement may be displayed to the end user after the end user selects to start and/or resume a session. The present user agreement may set forth terms and conditions that the end user must agree to before proceeding further into the session. As another option, after starting or resuming a session, a set of overview instructions may be presented to the end user that provide directions for going through the session and on what to expect during the session.

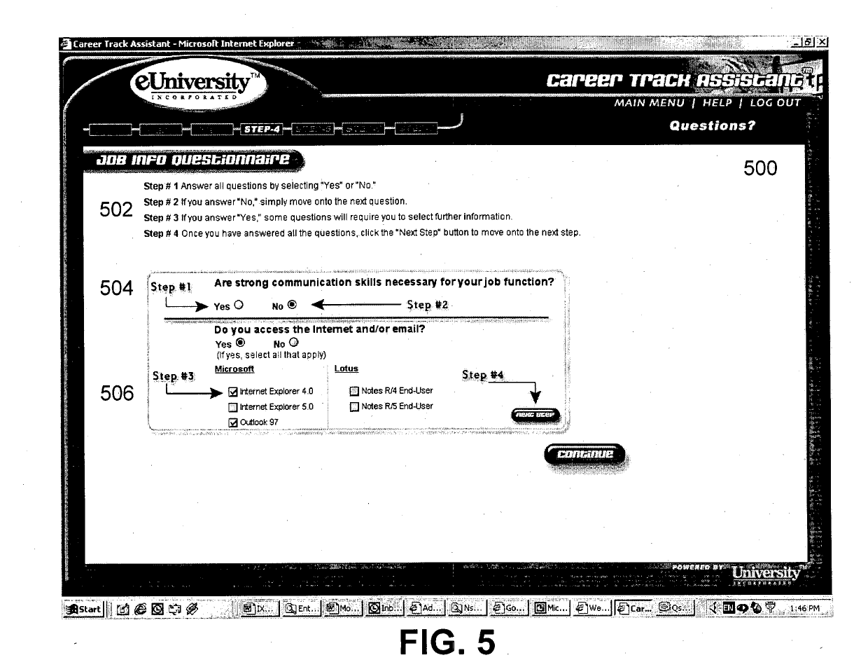

FIG. 5 is a schematic representation of an exemplary introductory display 500 for a first set of questions that generally relate to the end user's current job position (a “job information questionnaire”) during a session with a career track assistant application in accordance with an embodiment of the present invention. The introductory display 500 may include instructions 502 for answering the first set of questions and may also include sample questions and answers 504, 506. As illustrated in FIG. 5, the questions in the first set of question may simply require a yes or no answer by the end user (e.g., sample question and answer 504 with some of the questions requiring the answering of additional follow up related questions when the end user answers “yes” to the question (e.g., sample question and answer 506).

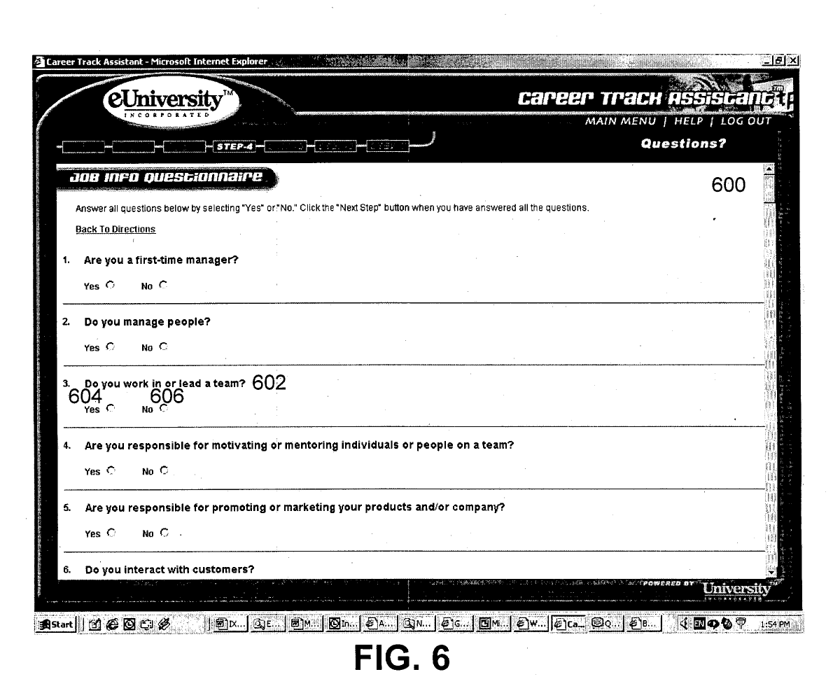

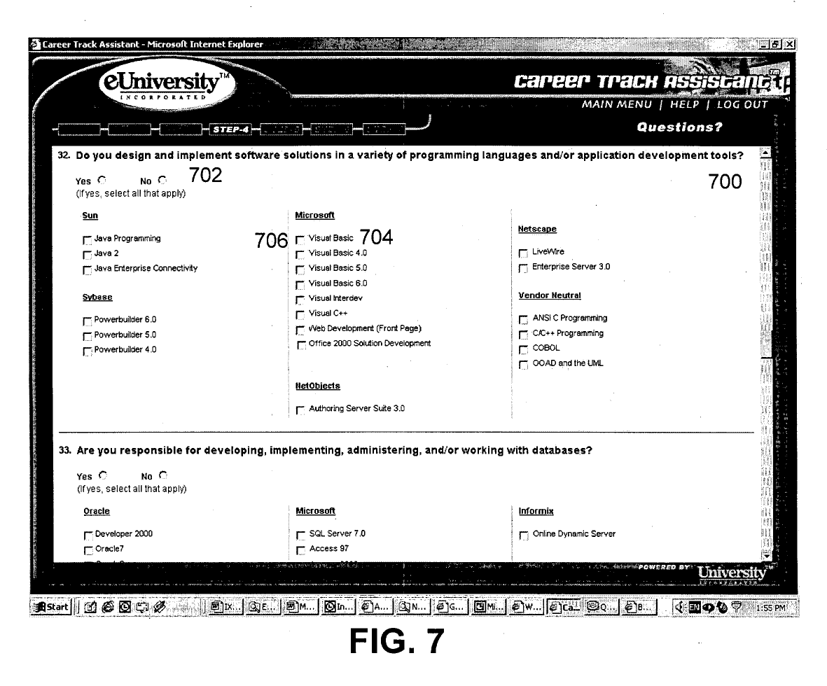

FIGS. 6 and 7 are schematic representation of exemplary displays 600, 700 for presenting the first set of questions that generally relate to the end user's current job position during a session with a career track assistant application in accordance with an embodiment of the present invention. As illustrated in FIG. 6, in the first set of questions, the end user is presented with generalized high-level questions (e.g., question 602) requiring yes or no answers from the end user specific to their current job. For example, in the first set of questions, the end user may be presented questions as to whether the end user is a first time manager, works in or leads a team, responsible for problem solving, interacting with customers, and so on. Adjacent to each question, a user-selectable set of yes and no answers 604, 606 (such as e.g., user-selectable radio buttons) to the question may be displayed.

As illustrated in FIG. 7, adjacent some of the questions 702 of in the first set of questions having a user-selectable set of yes and no answers, may be additional and more detailed follow up questions or selections 704 related to the initial question. For example, for an initial question relating to whether the end user uses or interacts with software or other technology in their current job position or particular job function, (such as e.g., whether the end user designs and implements software solutions in a variety of programming languages and/or application development tools or, e.g., whether the end user uses a particular operating system such as Microsoft's Windows OS), a plurality of follow up questions or selections 704 relating to different types or suppliers of software or technology (e.g., Java Programming language by Sun, Powerbuilder 6.0 programming language by Sybase, Visual C++ programming language by Microsoft, etc.) may be presented below the initial question 702 to the end user. Each follow up question or selection 704 may be user-selectable by, for example, presenting there adjacent a user-selectable box 706 in which a check mark or other indicator is displayed if selected by the end user.

The answers input by the end user to each of the specific questions in the first set of questions are collected and analyzed by the career track assistant application to dynamically select and/or generate at least a portion of the remaining questions in the series of questions (i.e., the second and third sets of questions) presented to the end user during the session. This way, the end user is presented a customized set of questions that are tailored to that particular end user based on the end user's answers to the previously presented questions (i.e., at least the first set of questions).

As on option, after the first set of questions have been presented to the end user, the end user may then be prompted to indicate when they are ready to proceed with the next set of questions in the session. At this point, the career track assistant application may perform a check to make sure that all of the questions of the first set of questions have been answered properly and/or completely by the end user. If the career track assistant application determines that not all of the questions have been answered properly or completely, the career track assistant application may then re-present the improperly or incompletely answered questions to the end user so that the end user can properly or completely answer the re-presented questions.

Identify and Rank Skills Required

Based on the on the analysis of the collected end user's answers to the first set of questions, the second set of questions for identifying and ranking skills relating to the end user's current job are generated/selected by the career track assistant application.

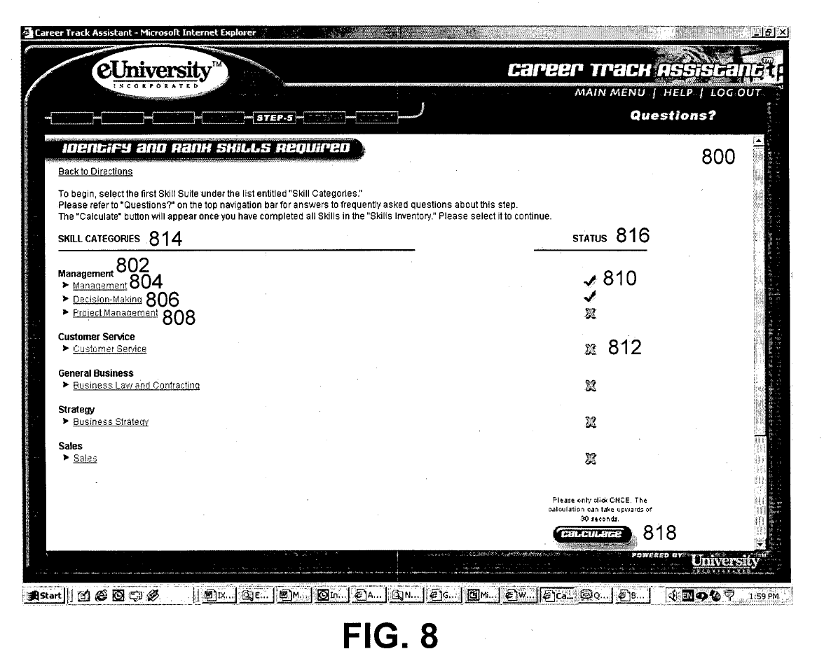

FIG. 8 is a schematic representation of an exemplary status display 800 for a second set of questions for identifying and ranking skills relating to the end user's current job position during a session with a career track assistant application in accordance with an embodiment of the present invention. The status display 800 may serve to provide the end user with an outline of each of the topics on which the end user will be questioned in the second set of questions of the session. The status display 800 may present one or more categories of skills (“skill categories”) 802 to the end user. The skill categories in the status display 800 may be selected by the career track assistant application based on the analysis of the collected end user's answers to the first set of questions. In an illustrative embodiment, skill categories may include, for example: a management skill category, a customer service skill category, a general business skill category, a strategy skill category, a sales skill category, a human resources skill category, a communications skill category, a leadership skill category, an operating systems skill category, and a desktop applications skill category.

Adjacent each skill category 802, the status display 800 may also present one or more user selectable skill sets (“skill suites”) 804, 806, 808 associated with the respective skill category. In use, the user selects one of the user selectable skill suites to access a series of questions associated with the selected skill suite. Some exemplary skill suites associated with the illustrative skill categories may include management, decision making and project management skill suites associated with the management skill category, a customer service skill suite associated with the customer service skill category, a business law and contracts skill suite associated with the general business skill category, a business strategy skill suite associated with the strategy skill category, a sales skill suite associated with the sales skill category, human resource management and labor relations skill suites associated with the human resources skill category, communications and conflict management skill suites associated with the communications skill category, a leadership skill suite associated with the leadership skill category, a computing basics skill suite associated with the operating systems skill category, and a skill suite associated with a particular software application (e.g., a Microsoft Office 2002 skill suite) associated with the desktop applications skill category.

Associated with each skill suite, the status display 800 may further present some sort of status indicator 810, 812 that indicates whether or not an end user has completed answering questions associated with the respective skill suite. In one embodiment, a not-completed or incomplete status indicator 810 for a skill suite (indicating that that end user has not completed answering the questions of the skill suite) may be represented by a “X” while a completed status indicator 812 for a skill suite (indicating that that end user has completed answering the questions of the skill suite) may be represented by a checkmark.

As illustrated in FIG. 8, as an option, the skill categories may be arranged on the status display 800 in a skill category column 814 with the skill suites associated with each skill category presented beneath the associated skill category and the status indicators may be displayed across from their associated skill suite in a status column 816.

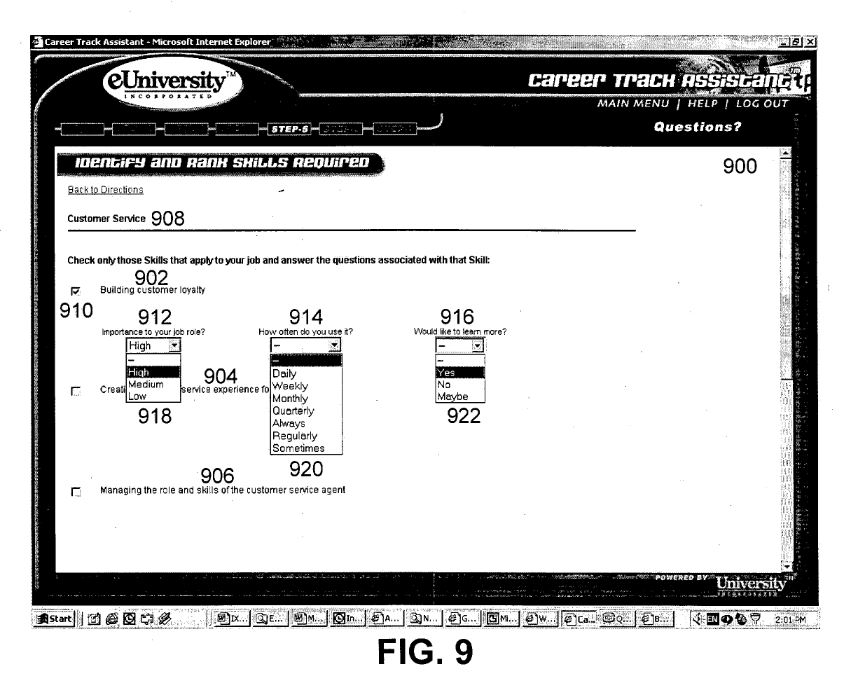

FIG. 9 is a schematic representation of an exemplary display 900 for presenting a second set of questions for identifying and ranking skills or functions relating to the end user's current job position during a session with a career track assistant application in accordance with an embodiment of the present invention. Upon selecting a skill suite in the status display 800, the end user may be presented with the set of skills or functions 902, 904, 906 associated with the skill suite in display 1300. As an option, the display 900 may include an indication 908 identifying the selected skill suite.

As illustrated in FIG. 9, the layout of each of the presented skills 902, 904, 906 may be similar. Adjacent each skill/function may be an associated user selectable selection box 910 with which the end user may select the respective skill/function. Upon selection of a skill/function by the end user via the associated selection box 910, the career track assistant application may dynamically display a set of questions 912, 914, 916 associated with the skill with a set of user-selectable predetermined answers 918, 920, 922 adjacent each question. As illustrated the user-selectable answers 918, 920, 922 may be presented to the user via drop-down selectable menus so that the end user may easily select one of the predetermined answers.

In one embodiment, the questions 912, 914, 916 presented for each skill/function 902, 904, 906 may be the same or similar to each other. In the exemplary embodiment illustrated in FIG. 9, the first question 912 for each skill/function may ask the end user to identify the importance that this skill/function has in their job by, for example, selecting a ranking of either High, Medium, or Low importance from the drop down box 918. The second question 914 for each skill/function may ask the end user to disclose how often (i.e., frequency) the end user uses the particular skill/function in their job roll by selecting the most appropriate answer from the drop down menu 920 (e.g., daily, weekly, monthly, quarterly, always, regularly, or sometimes). The third question 916 for each skill/function may ask the end user to indicate whether the end user would like to learn more about the particular skill/function in question (or, in other words, whether the end user feels that knowing more about this particular job skill/function would enable the end user to perform better at their job) by selecting either a yes, no or maybe answer from the associated drop down menu 922.

In use, the answers selected by the end user from the pull down menus 918, 920, 922 may be collected for analysis by the career track assistant application. The end user may answer the three questions for each of the skills/functions under the particular skill suite/topic in display 1300 until completed. In one embodiment, the end user may not be required to answer all of the presented questions of the selected skill suite but rather only have to answer those questions which the end user believes are relevant to their job. Upon completion, the status display 800 may be redisplayed to the end user with a completed status indicator 812 provided for completed skill suite. The status display 800 may also display a user-selectable selection 818 that indicates, upon selection, to the career track assistant application that the end user has completed answering the second set of questions and is ready to proceed to the third set of questions.

Defining Job Responsibilities

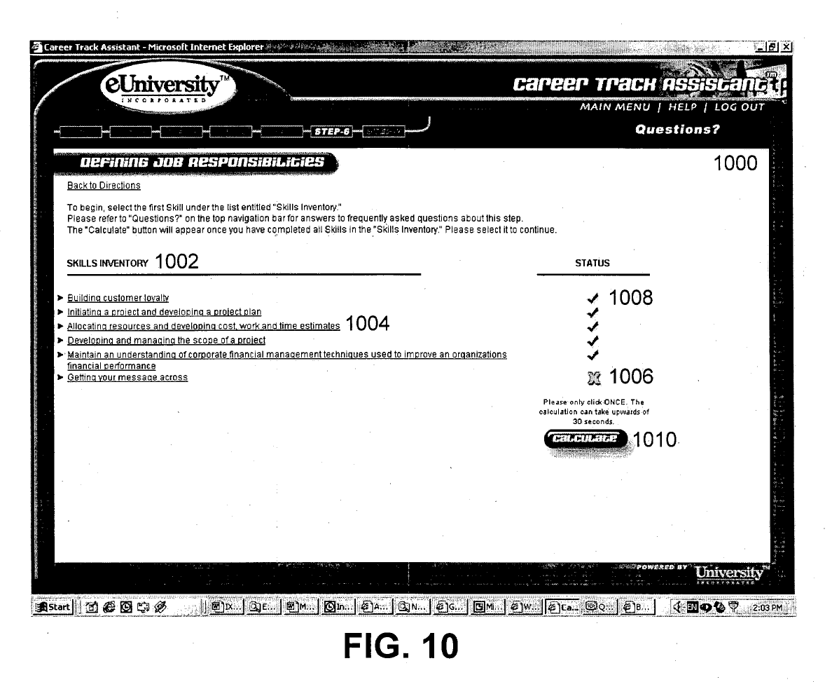

FIG. 10 is a schematic representation of an exemplary status display 1000 for a third set of questions for defining skills and responsibilities relating to the end user's current job position during a session with a career track assistant application in accordance with an embodiment of the present invention. Presented in the display 1000, is a ranked list (“skills inventory”) 1002 of user-selectable skills/job functions 1004 that have been identified through the analysis by the career track assistant application based on the inputs proved by the end user in the first and second set of questions. In one embodiment, the third set of questions may go into greater detail about each individual skill/function to better understand the end user's position, job function and training needs. Similar to the status display 800 for the second set of questions, the status display 1000 may also indicate the end user's status or progress through the by using an incomplete indicator 1006 (e.g., an “X”) for incomplete and a complete indicator 1008 (e.g., a checkmark) for complete for each of the skill/functions to indicate whether or not the end user has completed the questions associated with a particular one of the skills/job functions 1004. The status display may also include a user-selectable selection 1010 that indicates, upon selection, to the career track assistant application that the end user has completed answering the second set of questions and is ready to proceed to the next portion of the session. In an illustrative embodiment, the end user may select this selection 1010 once the end user has worked through each of the ranked list of skills/functions (i.e., they have a checkmark next to each skill/function), so that end user may proceed with the session with the career track assistant application.

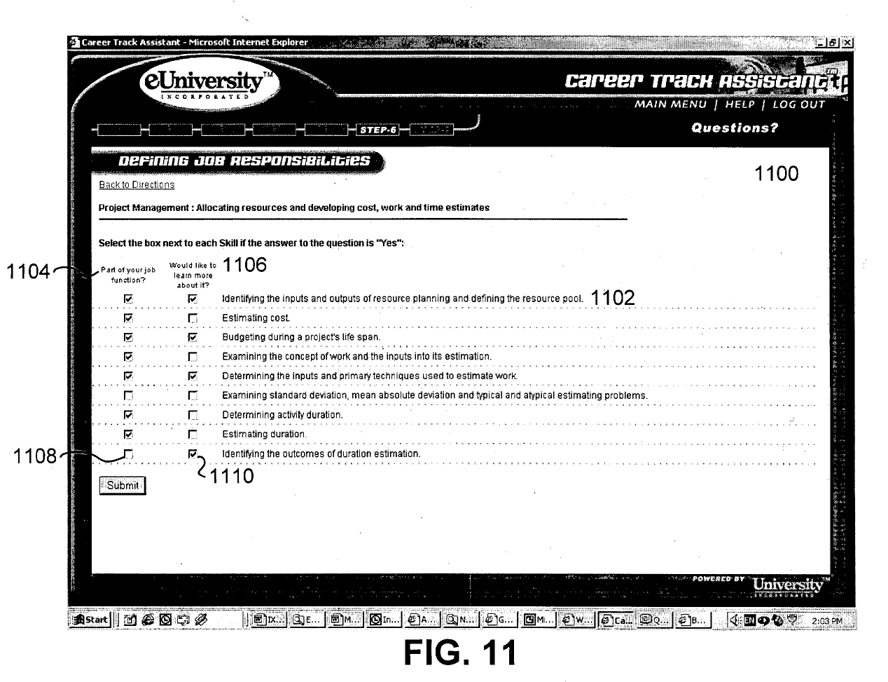

FIG. 11 is a schematic representation of an exemplary display 1 100 for presenting user-selectable skill object selections to an end user of a third set of questions for defining skills and responsibilities relating to the end user's current job position during a session with a career track assistant application in accordance with an embodiment of the present invention. Upon selection by the end user of one of the user-selectable skills/job functions 1004, the career track assistant application may present the display 1100 which presents a plurality of skill objects 1102 associated with the selected skill/job function 1004. With the display 1100, the career track assistant application may pose specific questions to the end user about the selected skill/function. The plurality of skill objects make up the specific selected skill. In one embodiment, the end user may be asked two questions about each skill object 1102. The first question 1104 asks the end user to place a checkmark (e.g., checkmark 1108) next to each of the skill objects 1102 that are part of end the user's job function. The second question 1106 asks the end user to place a checkmark (e.g., checkmark 1110) in the appropriate box next to each of the objects to indicate that the user would like to learn more about or if knowing more about this particular skill object would be helpful to end user in carrying out their job. During the completion of and/or after completing the third set of questions via displays 1000, 1100, the career track assistant application analyzes all of the end user's inputs (i.e., answers to the posed questions) given throughout the session and generates/develops a customized personal learning plan for the end user based on the analysis. At this point, the career track assistant application may present the personal learning plan to the end user or prompt the end user whether the end user would like to review the personal learning plan.

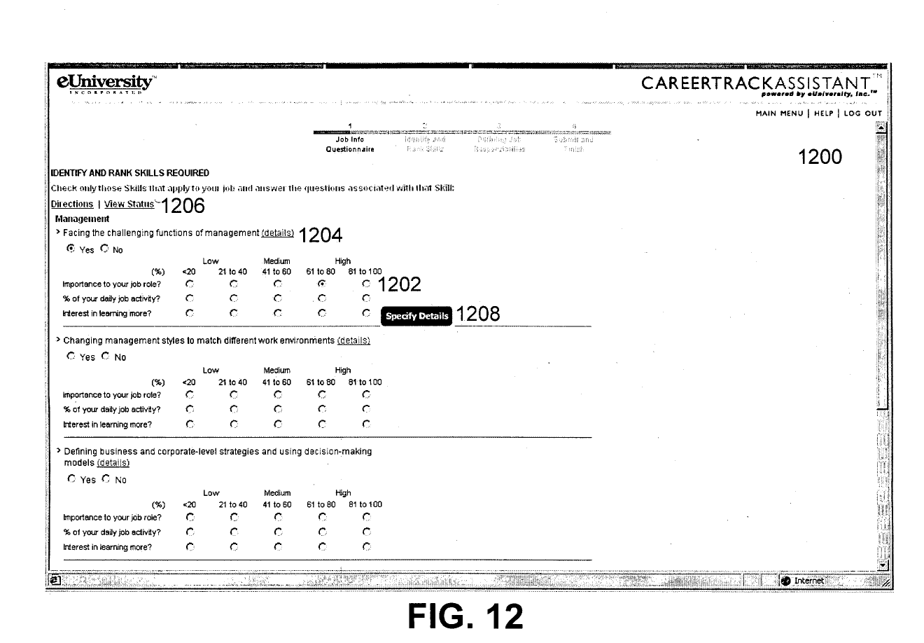

FIG. 12 is a schematic representation of an exemplary display 1200 as an alternative option to the display 900 of FIG. 9 for presenting a second set of questions for identifying and ranking skills or functions relating to the end user's current job position during a session with a career track assistant application in accordance with an embodiment of the present invention. In this embodiment, the answers to the second set of questions for identifying and ranking skills or functions relating to the end user's current job position are presented as a selection of radio buttons (e.g., radio button 1202) for scale of low, medium or high percentages. Display 1200 also includes a user-selectable details link 1204, a user-selectable view status link 1206 and a user-selectable specify details link.

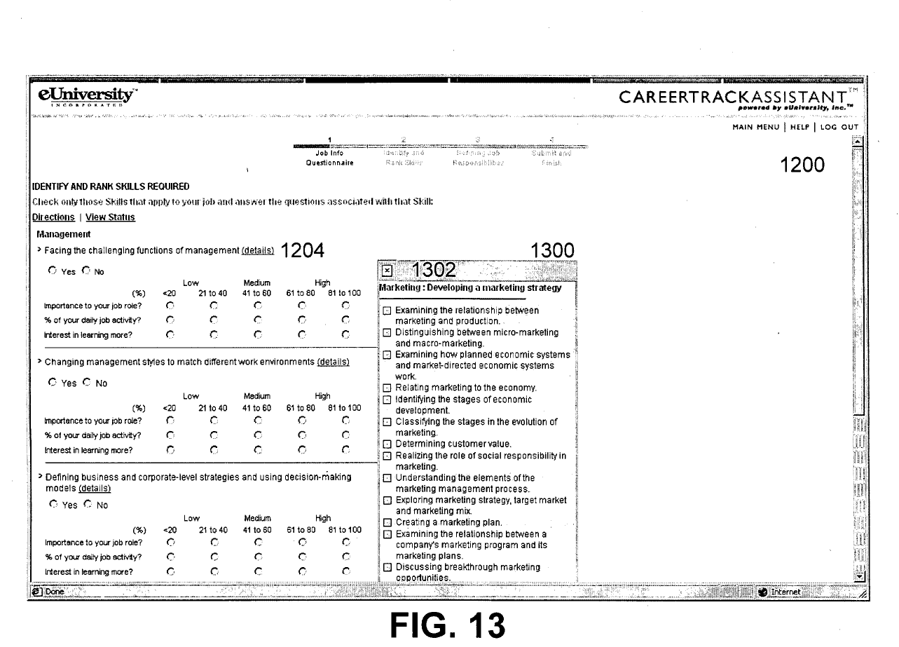

FIG. 13 is a schematic representation of an exemplary details display 1300 presented to an end user by a career planning and managing application upon selection of a details link 1204 of the display 1200 illustrated in FIG. 12. This display 1300 may include a listing 1302 of the detailed skill objects for this particular skill associated with the link 1204 (pulled from the database). With this display 1300, the end user may be able to obtain further information about the skill/skill object to answer the questions presented in display 1200 more accurately.

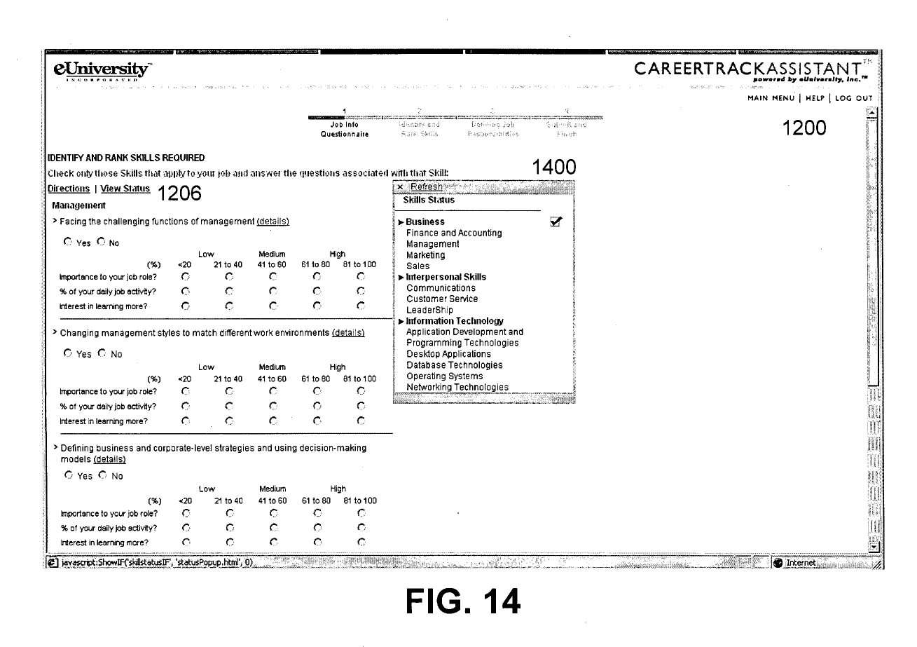

FIG. 14 is a schematic representation of an exemplary skills status display 1400 presented to an end user by a career planning and managing application upon selection of a view status link 1206 of the display 1200 illustrated in FIG. 12. This display 1400 may include status information similar to that displayed in the display 800 of FIG. 8. With this exemplary embodiment, the status information may be integrated in the second set of questions presented to the end user.

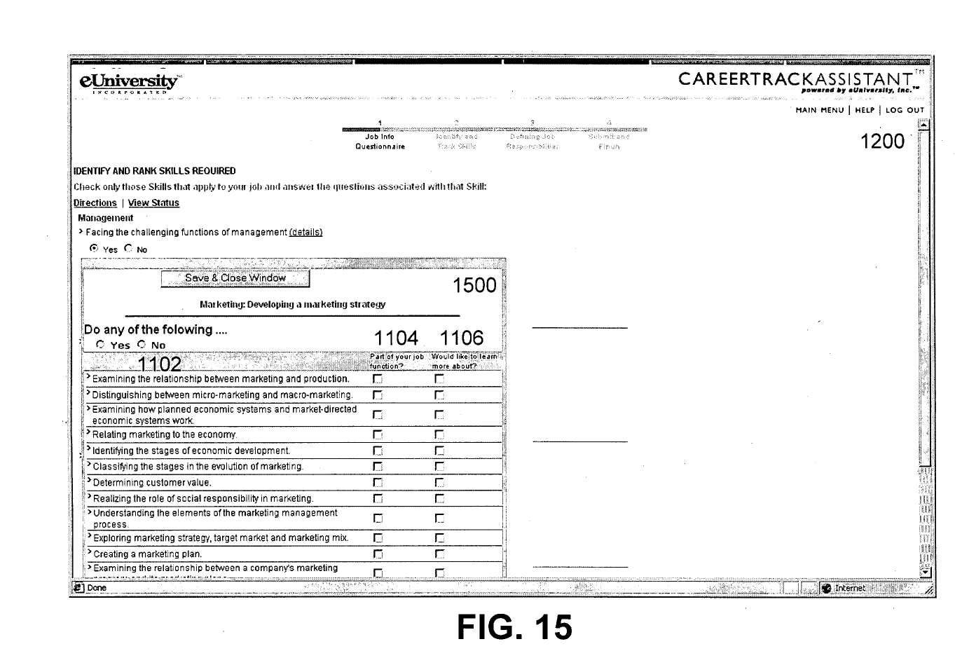

FIG. 15 is a schematic representation of an exemplary specify details display 1500 presented to an end user by a career planning and managing application upon selection of a specify details link 1208 of the display 1200 illustrated in FIG. 12. With this exemplary display 1500, the questions and answers 1102, 1104, 1106 normally presented in the display 1100 of FIG. 11 may be presented to the end user during the second section of questions. This way, the end user can have the option of answering these detailed questions about the skill/skill object immediately and avoid having to have view display 1100. However, if the end user does not complete the entries presented in display 1500, the career planning and managing application will introduce the unanswered questions in the corresponding display 1100 as set forth in FIG. 11.

Personal Learning Plan

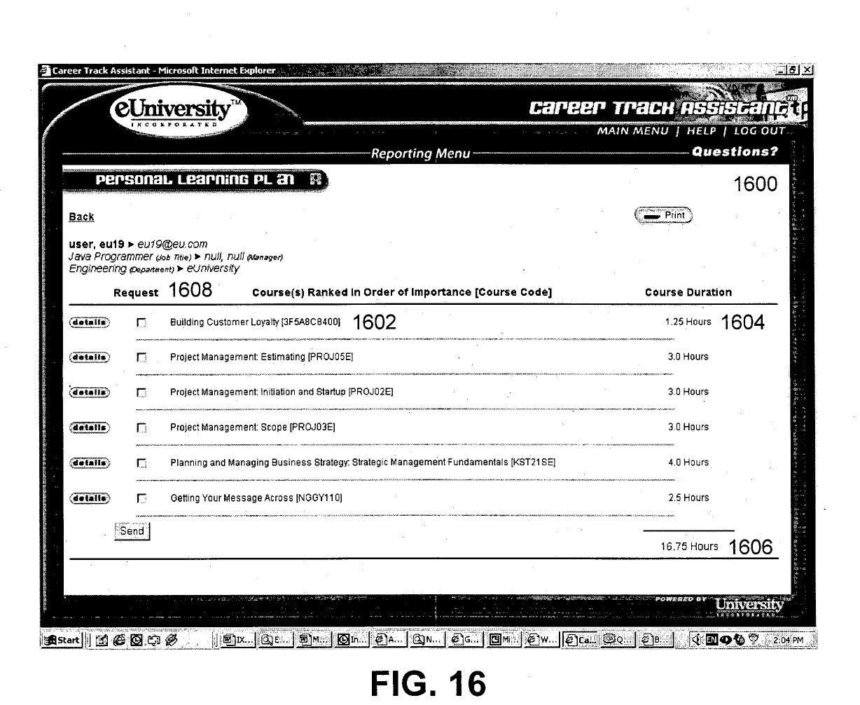

FIG. 16 is a schematic diagram of an exemplary display 1600 for presenting a personal learning plan to an end user in accordance with an embodiment of the present invention. In one embodiment, the career track assistant application may utilize such a display 1600 to present the generated personal learning plan that was customized to the end user based on the analysis of the end user's answers to the questions session with the career track assistant application. The personal learning plan may comprise one or more courses (e.g., course 1602) with an indication 1604 of the duration of the course (i.e., the time it takes to complete the course). The personal learning plan may also include an indication 1606 that indicate the total amount of time to complete all of the courses of the personal learning plan. As illustrated in the illustrative display 1600 for the personal learning plan, the career track assistant application may also display each course in order of their importance ranking (e.g., the first course 1602 listed at the top of the list being the highest importance course to take). The user may have the ability to request certain courses to take from their personal learning plan by clicking on the appropriate check box under the “REQUEST” column 1608, next to the course(s) they wish to request to take. As an option, this information, including the users entire Personal Learning Plan and requested courses may then be made available to the end user's their respective manager for final approval. The manager may also be able to assign other courses in addition to or in lieu of the courses that the end user requested.

Training Hours Report

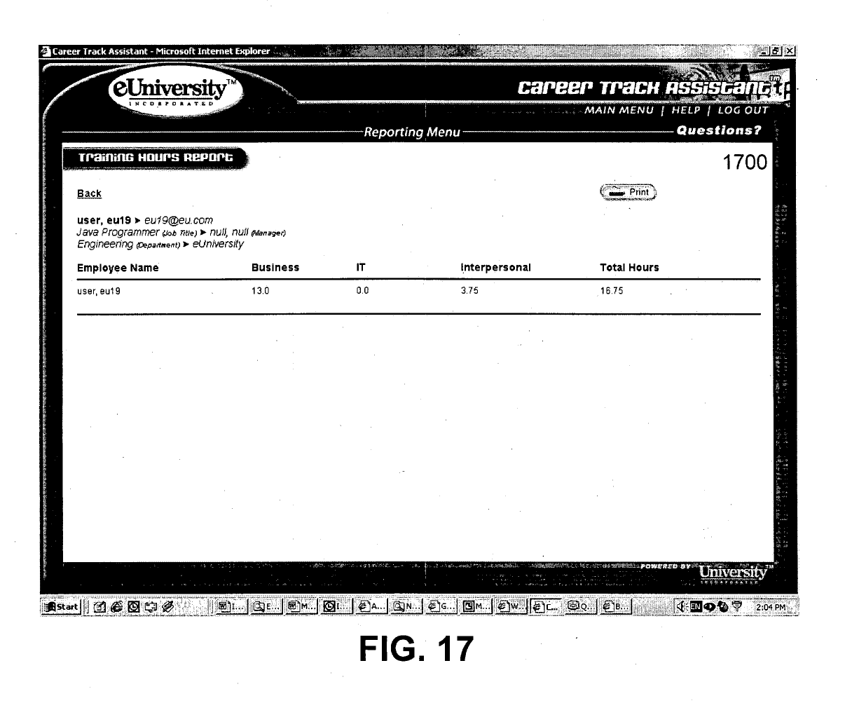

FIG. 17 is a schematic diagram of an exemplary display 1700 for presenting a training hours report in accordance with an embodiment of the present invention. In addition to being able to view a personal learning plan recommended by the career track assistant application based on its analysis of the answers to the posed questions, the end user may also be able to view a training hours report that shows all of the types of training and corresponding hours. An end user's manager may also be able to access the training hours report of the end user.

Manager End User

The career track assistant application may also include managerial features for an end user with managerial privileges (i.e., a manager end user). The managerial features of the career track assistant application may be accessed by the manager end user via a network portal. In one exemplary embodiment, the managerial features may be accessed via an administrative options link on the network portal.

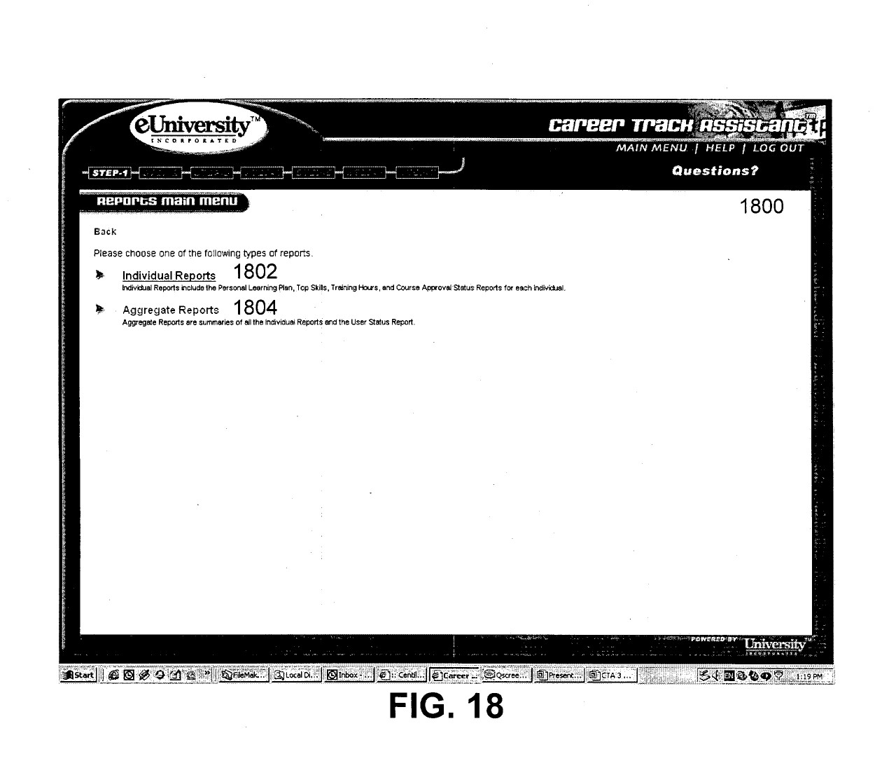

FIG. 18 is a schematic diagram of an exemplary main menu display 1800 from which an authorized end user may generate and review reports about an individual end user (via a user selectable individual reports link 1802) or an aggregated group of end users (via a user selectable aggregate reports link 1804) utilizing the career planning and managing application in accordance with an embodiment of the present invention. The managerial features of the career track assistant may permit a manager end user to have the option of selecting both individual reports about a single end user or aggregate reports about a group of end users. In one embodiment, the end users about whom the reports are based may be employees (i.e., employee end users) under the supervision of the manager end user.

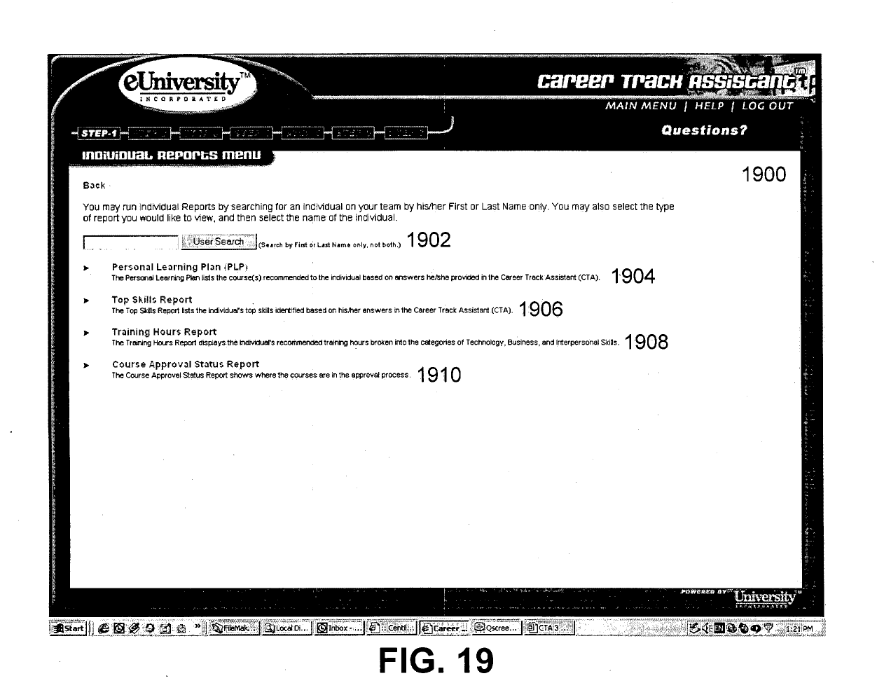

FIG. 19 is a schematic diagram of an exemplary individual reports menu display 1900 accessible upon selection of the individual reports link 1802 in accordance with an embodiment of the present invention. Upon accessing an individual reports menu 1902, a manager end user may have the option of running a search for a specific individual by searching by last or first name via a search field 1902. In addition, if the manager end user is looking to generate a specific report such as a personal learning plans report or a top skills report, the manager end user may can select the desired report title (e.g., user selectable links 1904, 1906, 1908, 1910) to view the results of the employee end users under the manager end user's supervision.

Personal Learning Plan Report

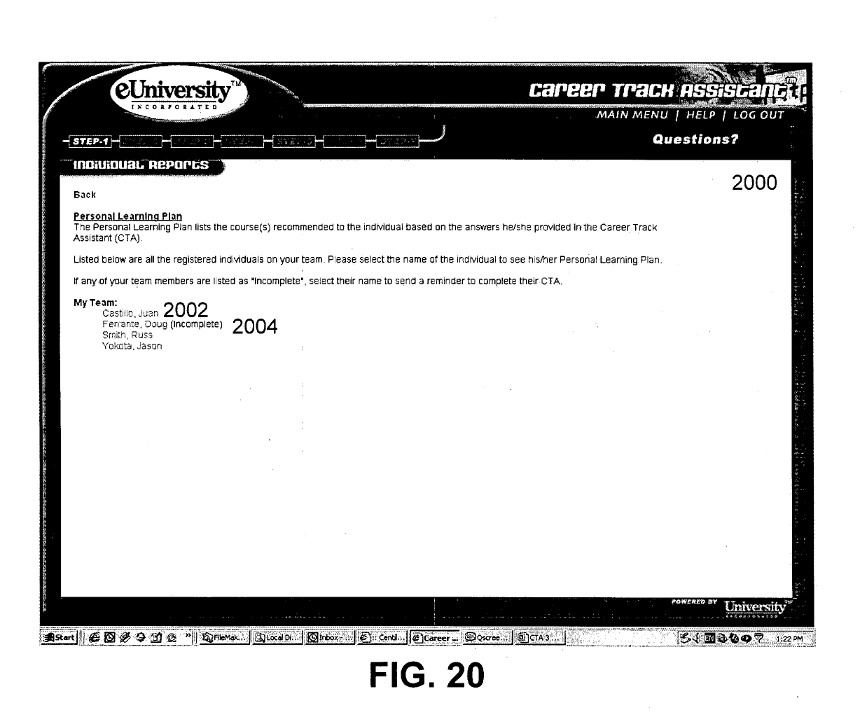

FIG. 20 is a schematic diagram of an exemplary display 2000 for generating a personal learning plan in accordance with an embodiment of the present invention. In this case, each of a manager end user's employees personal learning plans may be accessible by clicking the associated link displaying their name (e.g., link 2002 for the end user named Juan Castillo). In addition, an “Incomplete” indicator 2004 may be displayed to the right of each employee if they have not yet completed their session with the career track assistant application. In an exemplary scenario, if the manager end user is interested, for example, in viewing the personal learning plan results of the employee end user named Juan Castillo, the manager end user simply selects the selection called “Juan Castillo” to view this person's results.

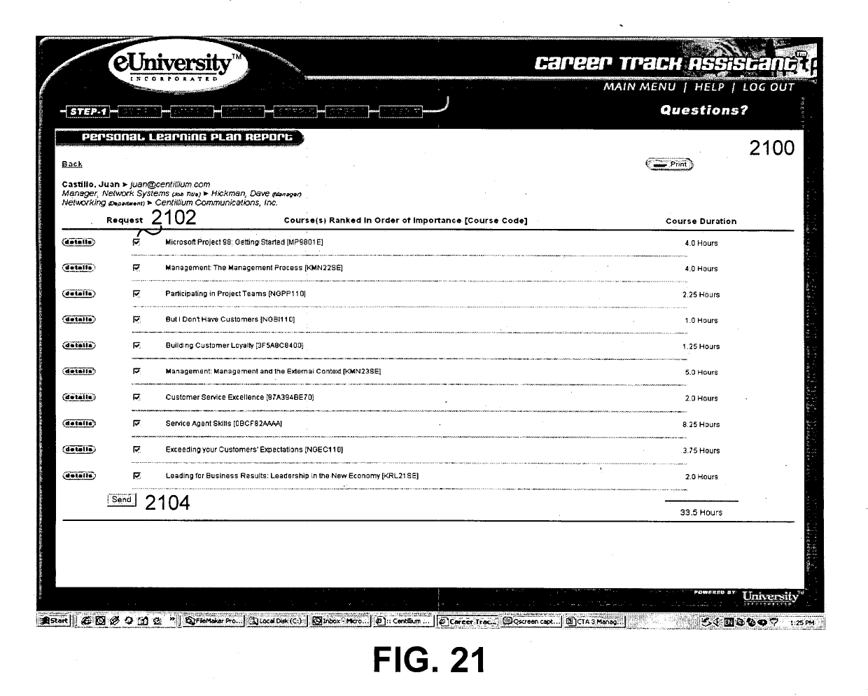

FIG. 21 is a schematic diagram of an exemplary display 2100 for presenting an individual personal learning plan in accordance with an embodiment of the present invention. At this point, the manager end user may approve or reject courses suggested for the employee end user by selecting the appropriate boxes (e.g., selectable box 2102) and clicking send link 2104 located at the bottom of the displayed page. An asterisks (“*”) adjacent any course may be utilized to represent courses that the employee end user specifically requested after viewing the results of their session with the career track assistant application. Upon receiving the approval by a manager end user of one or more courses in a personal learning plan, the career track assistant application may then add the approved course(s) to the employee end user's learning platform and send a confirmation via email or other means to the manager end user and/or employee end user stating that the course(s) is now available in the learning platform.

Top Skills Report

Using the appropriate link 1906 from the display 1900 of FIG. 19, a manager end user may also select to review a top skills report for a specific member of the manager end user's team. In this case, the manager end user may select the link “Top Skills” from the Individual Reports Main Menu. In the case, the manager end user may view the top skills reports of employee end users by selecting the link displaying the respective employee end user's name in a display similar to that set forth in FIG. 20. Continuing the previous exemplary scenario, if the manager end user is interested in viewing the employee end user Juan Castillo's top skills report, the manager end user selects the link “Juan Castillo” 2002 to generate and review the desired report.

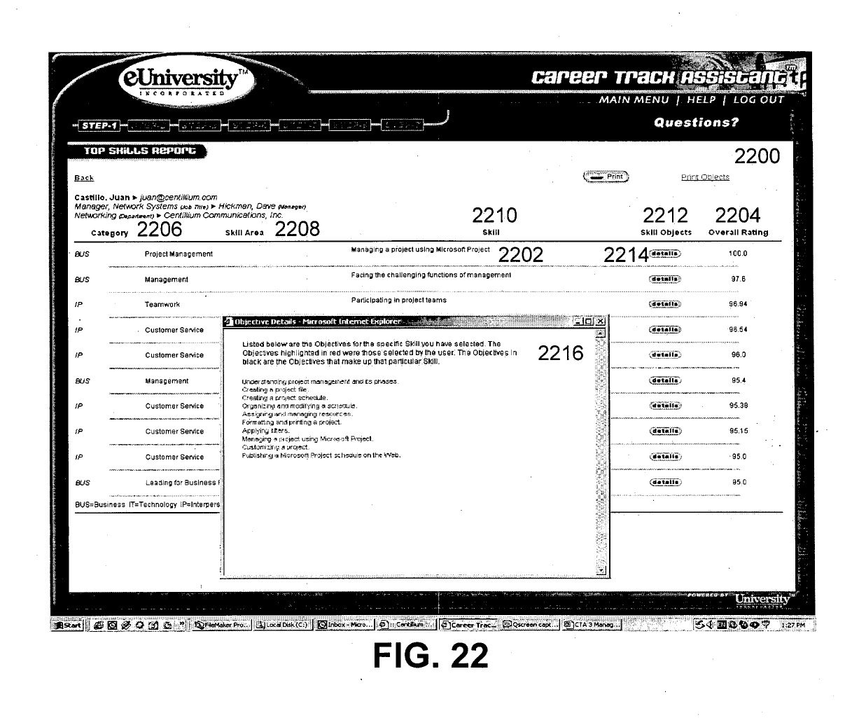

FIG. 22 is a schematic diagram of an exemplary display 2200 for presenting a top skills list in accordance with an embodiment of the present invention. The skills (e.g., skill 2202) may be listed in order based on the overall rating 2204 with a maximum of 100. This data may be organized into: 1) categories 2206, 2) skills areas 2208; 3) skills 2210; and 4) skill objects 2212. Each of the skills 2202 may include a user selectable details link 2214 in the skill objects column 2212. Upon selection of the details link 2214, a pop up display 2216 may be presented to the end user that displays the details of the skill object(s) associated with the particular skill (i.e., those skill objects that make up the particular skill). In addition, skill objects selected by the end user may be highlighted (e.g., presented in a colored text (e.g., red text).

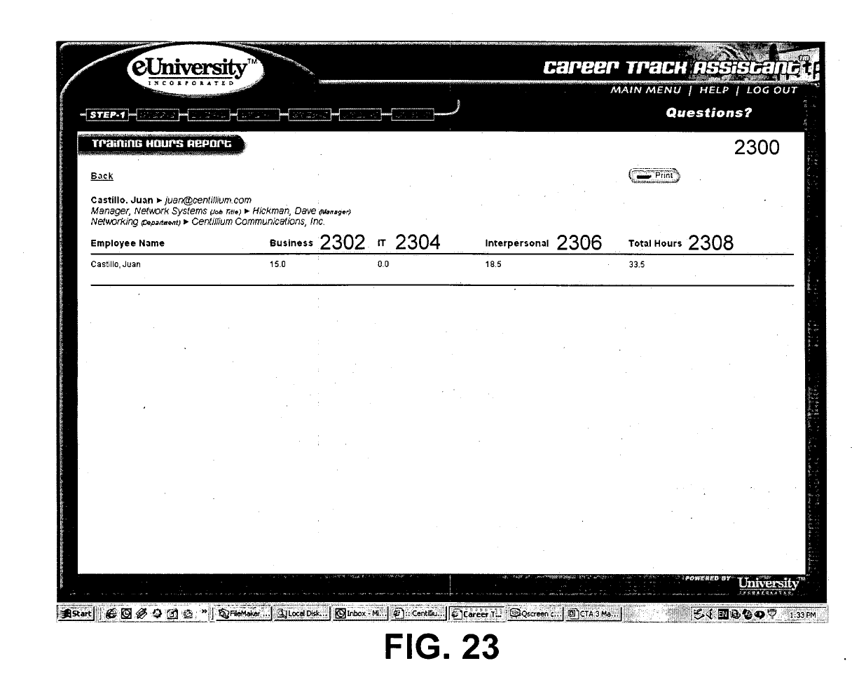

FIG. 23 is a schematic representation of an exemplary display 2300 for a training hours report approval status report in accordance with an embodiment of the present invention. In this report, the total number of course hours associated with each particular skill category (e.g., a business skills category 2302, an information technology skills category 2304, and an interpersonal skills category 2306) of a set of courses selected by the end user (and those added by the manager end user) and approved by the end user may be displayed to provide a quick visual review of the allocation of course hours for the selected end user. The total number of course hours 2308 for the end user's approved set of courses may also be displayed.

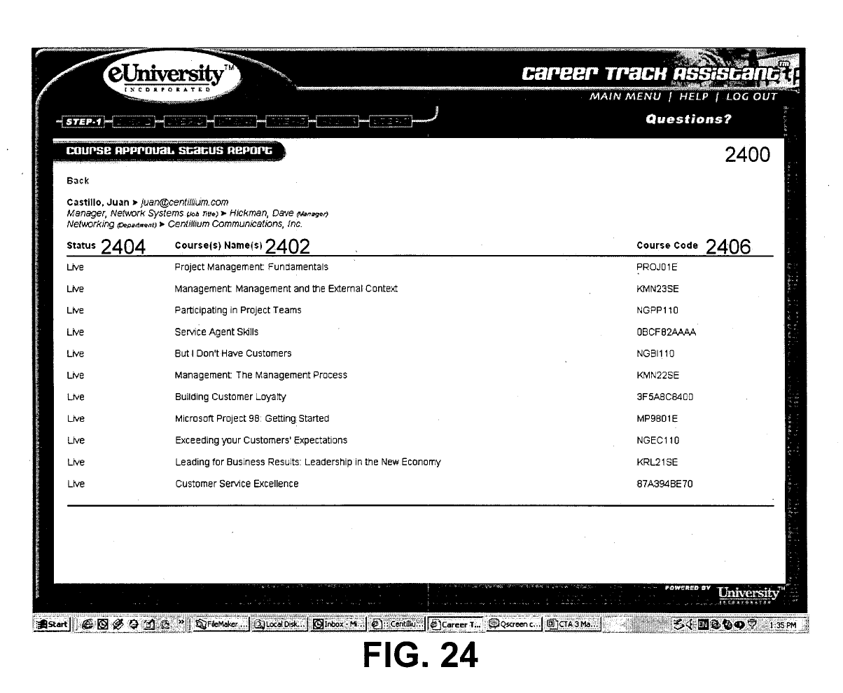

FIG. 24 is a schematic representation of an exemplary display 2400 for a course approval status report in accordance with an embodiment of the present invention. This report may include a list of the course names 2402, the status of the course 2404, and a code associated with the course 2406 (“course code”).

Aggregate Reports

Upon selection of the user selectable aggregate reports link 1804 in the display 1800 of FIG. 18, an aggregate reports menu may be displayed to the manager end user. The manager end user may also generate aggregate reports based on some or all of the employee end users under the manager end user's supervision. This may be accomplished using similar a display as the display 1900 set forth for the individual reports in FIG. 19. The manager end user may also select a plurality of employee end users so that the career track assistant may generate aggregated versions of the reports (e.g., an aggregate personal learning plans report, an aggregate top skills reports, etc.) that present the individual reports of the selected employee end users in an aggregated form. The aggregate reports generated by the career track assistant may also permit a manager end user to obtain status reports to determine the employee end users' progress through sessions with the career track assistant application. In an exemplary embodiment, the display presented to the manager end user may include a “User Status Report” selectable link to access status reports generated by the career track assistant application about the progress of the employee end users through sessions with the career track assistant. For those employee end users that have not completed their sessions with the career track assistant application, the manager end user may be able determine their current progress and generate send a pre-formatted reminder to the employee end user to complete their session at their earliest convenience.

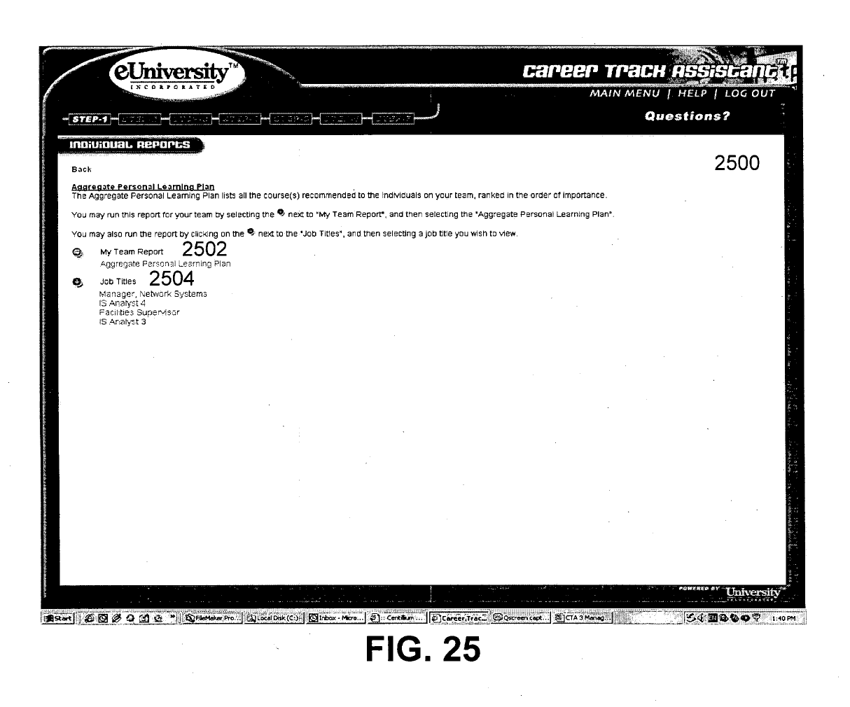

FIG. 25 is a schematic diagram of an exemplary display 2500 for selecting parameters for generating aggregate reports in accordance with an embodiment of the present invention. Aggregate reports may be generated based on end users under the supervision of the manager end user (e.g., “my team reports”) and/or by job titles of end users via the selection of the appropriate user selectable link (e.g., links 2502 and 2504).

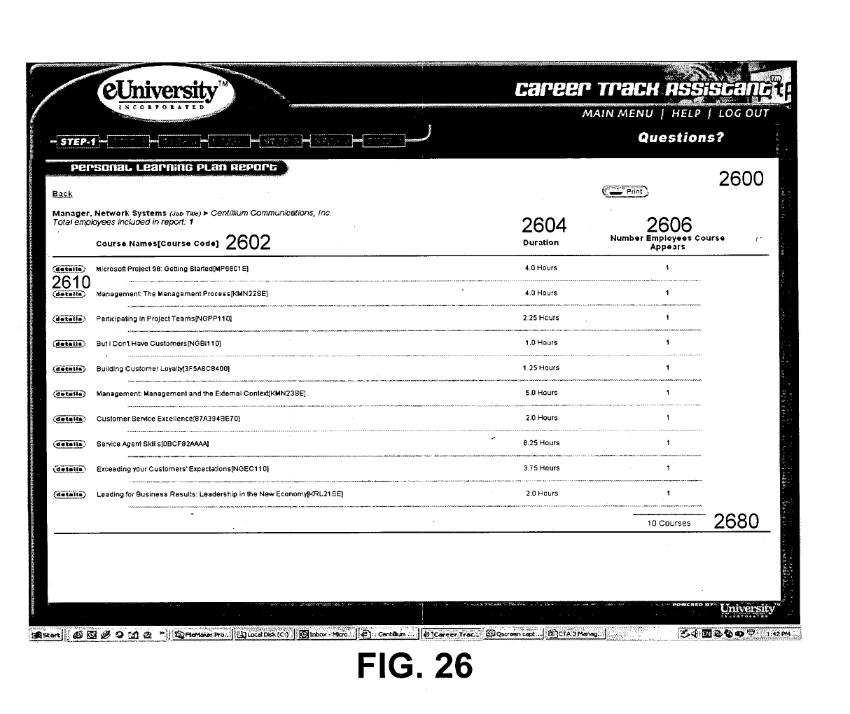

FIG. 26 is a schematic diagram of an exemplary display 2600 for an aggregate personal learning plan report based on selection of link 2502 of FIG. 25 (i.e., the my team report link) in accordance with an embodiment of the present invention. The generate aggregate personal learning plan report may include a list 2602 of all of the courses in the all of the learning plans of the end users under the supervision of the manager end user with a column 2604 indicating the duration of each course and a column 2606 indicating the number of end users under the supervision of the manager end user whom are selected to take the course. A total number of selected courses 2608 may also be displayed as part of the report along with user selectable links (e.g., link 2610) by which an end user can obtain additional information (i.e., details) about a particular course displayed in the list.

Administrator End User

The career track assistant application may also include features for an end user to administrating the career track assistant application (i.e., an administrator end user). In an exemplary embodiment, the career track assistant application may display a selectable administrative options link to permit an administrator end user to access the reports features of the career track assistant application.

Like the report features for the manager end user, the report features of the career track assistant application for the administrator end user may permit an administrator end user to select to have individual or aggregate reports generated by the career track assistant application.

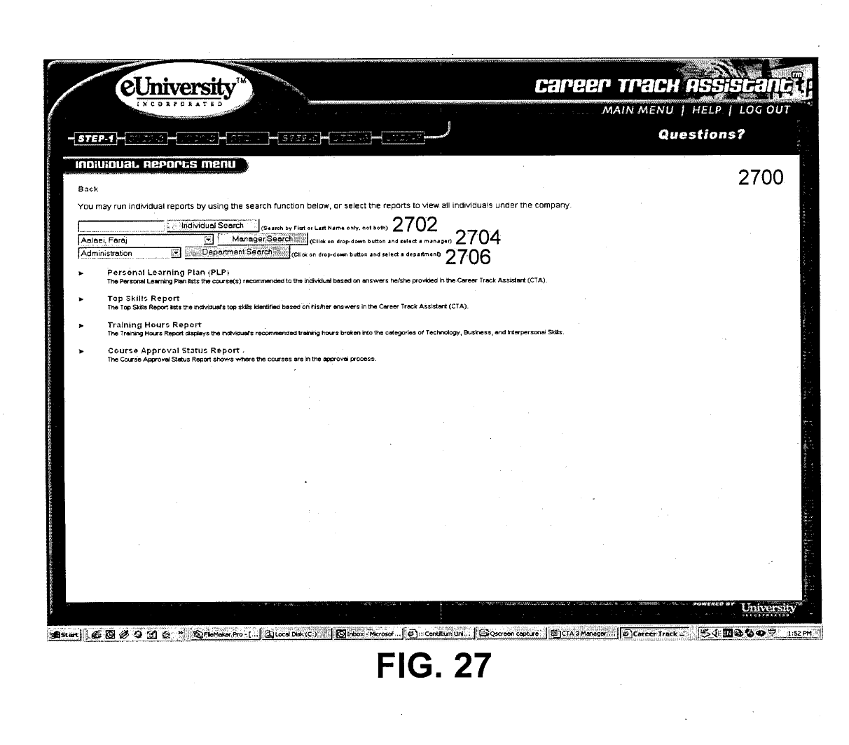

FIG. 27 is a schematic diagram of an exemplary display 2700 for generating reports by an end user having administrative powers with the curriculum planning and managing application in accordance with an embodiment of the present invention. In an exemplary embodiment, employee end users about whom the report is to be generated may be selected by the administrator end user by selecting selections presented to the administrator end user that are associated with aspects of the employee end users. For example, the selections may include job titles or departments so that an administrator end user may generate reports for employee end users by name (via fields 2702) or those having a particular job title or working under a particular manager end user (via fields 2704) or working in a particular department (via fields 2706).

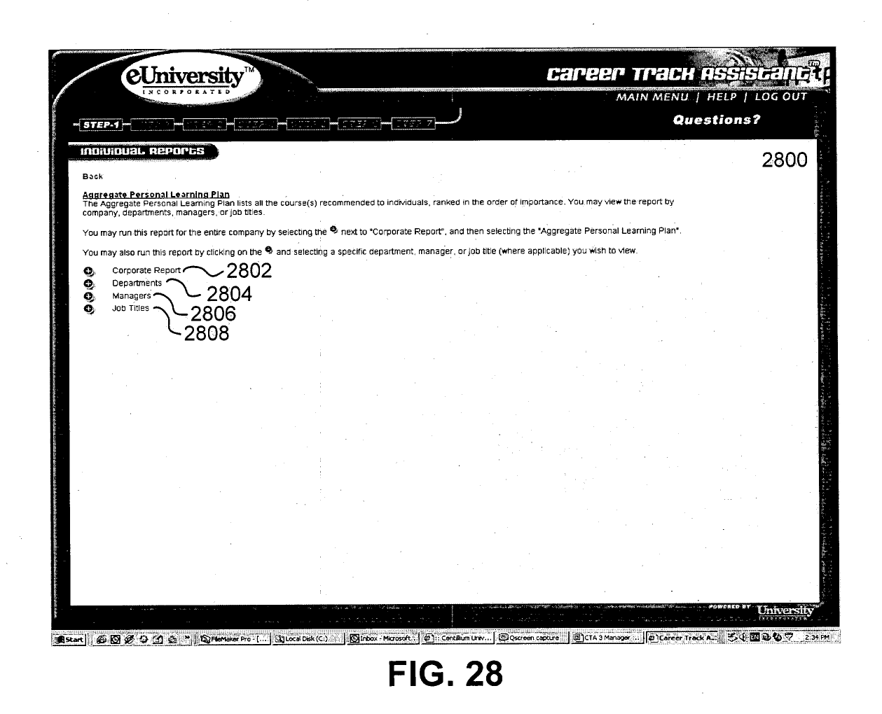

FIG. 28 is a schematic representation of a display 2800 for generating aggregate reports by an end user with administrative authority (i.e., an administrator end user) in accordance with an embodiment of the present invention. Once in the Aggregate Reports Menu, the administrator end user can generate an aggregate report by first selecting the report title of interest (via user selectable link 2802). To access an aggregate personal learning plan report, the administrator end user clicks the personal learning plan report selection. After selecting aggregate personal learning plan report, the administrator end user may have the option of running this report by: a specific department (via user selectable link 2804); a specific manager (via user selectable link 2806); a specific job title (via user selectable link 2808). This level of flexibility helps enables an administrator end user to look at their organizations learning needs from many different perspectives. In the illustrative scenario, the administrator end user may be looking to generate an aggregate personal learning plan by the job title “SW Development Engineer” and does so by expanding the job title menu and then selecting the respective job title displayed in the job title menu. The resulting aggregate personal learning plan for SW Development Engineer provides the summarized personal learning plan results of six employees that fit this job title. The courses that appeared most often in their respective personal learning plans may be displayed accompanied by the number of employees in which the respective course was recommended. This report helps an administrator end user the insight and ability to make relevant decisions regarding the learning needs of SW Development Engineers across the organization.

The administrator end user may also generate an aggregate personal learning plan report by a specific department. Continuing with the illustrative scenario, support the administrator end user is interested in viewing the aggregate personal learning plan for the sales department of the administrator end user's organization. In this situation, the administrator end user may be able to generate this report by expanding the department menu title and clicking the sales title. The generated aggregate personal learning plan for this selection provides the summarized personal learning plan results of fix employees in the sales department. The courses that appeared most often in their respective personal learning plans are displayed accompanied by the number of employees in which the respective course was recommended.

The career track assistant application may also permit an administrator end user to generate aggregate top skills report (like those by a manager end user) by: 1) a specific department; 2) a specific manager; and/or 3) a specific job title for an administrator end user. In the illustrative scenario, if the administrator end user is interested in generating an aggregate top skills report by the job title “regional sales manager,” the administrator may expand the job title menu and select the regional sales manager selection under the job title menu. The displayed skills may be listed in order based on the overall rating with a maximum rating of 100. In addition, this report may also identify the total number of employees in which a specific skill was identified via their respective individual top skills report.

In addition, the administrator end user may also be able to view an aggregate top skills report by a specific department. Let's assume that the admin is interested in viewing an aggregate top skills report of the sales department. To do this, the administrator end user expands the department menu and selects the sales selection. The skills are listed in the generated aggregate top skills report in order based on the overall rating with a maximum rating of 100.

An administrator end user may also be able to acquire a “snap-shot” of an organization's progress through sessions with the career track assistant application by selecting the user status report section. In this case, the administrator end user may be able to determine from the corporate level who is and who isn't complete. To do this, the administrator end user selects the aggregate user status report and everyone in the company and their progress through career track assistant application is displayed. For those that have not yet completed their career track assistant application session, the administrator end user may determine at which stage they are at and automatically send a pre-formatted reminder to the employee to complete the career track assistant application at their earliest convenience.

Job Description (Individual)

Upon completion of a session with a career track assistant application, an end user may be prompted to complete their job profile through a series of steps. To do this, the end user may be presented with a complete listing of the skills in which they had identified as being part of their job function while working through the session. This may be achieved in a manner described in the following illustrative scenario with the end user Jack Hayes, Senior Staff Engineer, DSP. Initially, Jack Hayes may be presented with the 10 skills, identified via the career track assistant, that comprise his duties and responsibilities. If after reviewing the listing of skills, Jack notices a need to add additional skills to complete his job profile, Jack may then select the “Add New Skill” link located at the bottom of the page. From here, Jack may input in the skill to be added in the field and clicks the “Search” selection to initiate the search for the skill. In this case Jack runs a search for “Managing Control and Quality Systems”. This skill is featured in the skills dictionary and displays enabling Jack to add this skill to his Job Profile. After clicking “Add”, Jack then ranks the skill based on importance/frequency and whether learning more about this skill will enable him to perform his job more efficiently. If in fact Jack ran a search on a skill such as “Controlling DSP” controls, in which case the skill is not part of the existing skills dictionary, Jack would be prompted to re-enter the skill name to add to his Job Profile by typing the skill in the field provided. Once again, Jack would then rank the skill based on importance/frequency etc. Once Jack has finished creating his Job Profile, he would click Complete.

Job Description (Manager)

A manager end user may be prompted to complete the Job Descriptions for their employees. To do this, the manager end user access the Job Description section of the career track assistant application. There the manager end user may be presented a listing of the Job Titles that report to the manager end user. An ‘X’ denotes that the job description for that job title is not complete where as a checkmark denotes that the job description is complete. To begin, the manager end user may click the job title of interest, in this case Senior Staff Engineer, DSP. The goal is to populate the four key areas including: Job Function section, Duties and Responsibilities, Knowledge, Skills and Abilities, and Additional Qualifications.

To begin, the manager end user may input a Job Function overview. The manager end user may provide as much as or as little information as deemed necessary. The next step may be to complete the Duties and Responsibilities section of the Job Description. The manager may select the most relevant skills from a number of perspectives: 1) by the individuals' Top Skills reports that are associated with this job title and report to this specific manager; 2) by the aggregate Tops Skills report reflective of those with the Senior Staff Engineer, DSP title within the manager's respective department; and 3) by aggregate Top Skills report reflective of those with the Senior Staff Engineer, DSP title across the entire organization. The Knowledge, Skills and Abilities section of the form may be automatically created based on the data provided from the Duties and Responsibilities section of the form. In addition, the manager end user may input additional qualifications such as specific degrees etc. Once the manager end user has finished creating the Job Description, the Job Function overview may be saved.

Exemplary Embodiment Flowchart

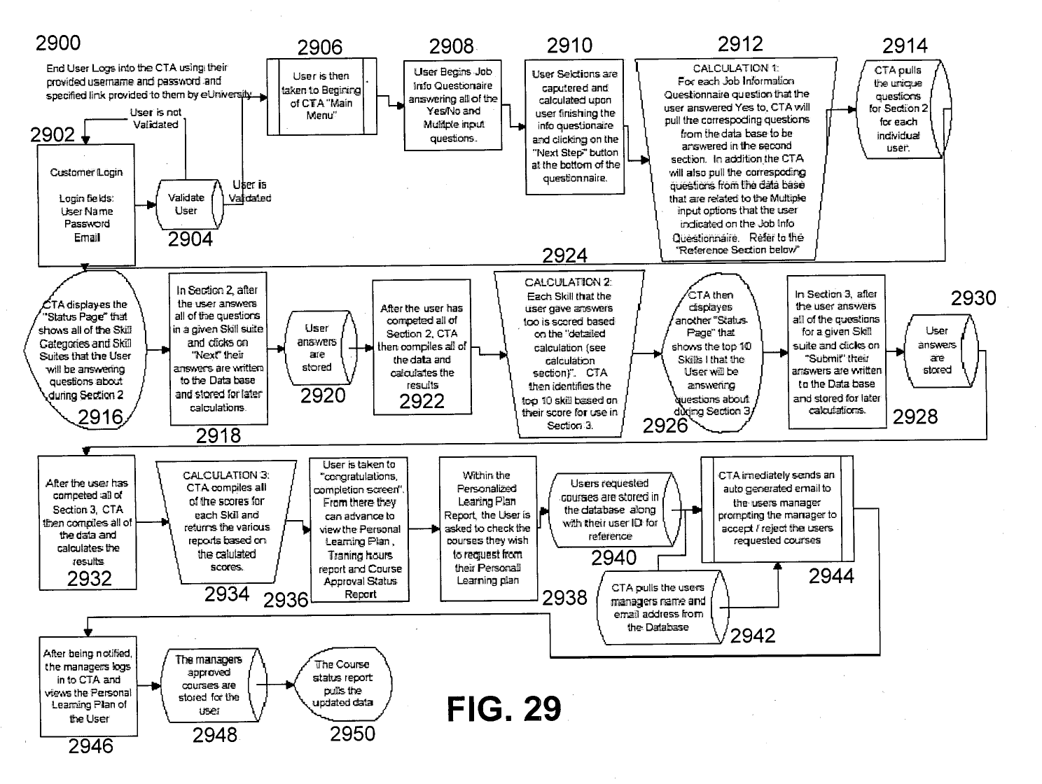

FIG. 29 is a flowchart of an exemplary detailed process 2900 for generating a customized course curriculum utilizing a curriculum planning and managing application in accordance with an embodiment of the present invention. This flow chart is based on the previously described exemplary embodiment. An end user may log into the CTA using a provided username and password and specified link via the network (see operations 2902 and 2904). In operation 2906, the end user may then be taken to beginning of a CTA “Main Menu.” In operation 2908, the end user may begin answering a plurality of generalized questions in a first section called “Job Info Questionnaire” and answer all of the Yes/ No and Multiple input questions. End user selections are captured and calculated upon the end user finishing the job info questionnaire and clicking on the “Next Step” button at the bottom of the questionnaire in operation 2910.

In operation 2912, a first calculation (Calculation 1) may be performed as part of the analysis by the CTA. For each job information questionnaire question that the user answered Yes to, CTA may pull the corresponding questions from the database to be answered in a second section of the questions presented to the end user. In addition the CTA may also pull the corresponding questions from the database that are related to the multiple input options that the user indicated on the Job Info Questionnaire. In one embodiment, first calculation may be performed as follows: For each “Yes / No” question answered “YES” on the Job Info questionnaire—return the corresponding Skill Suite(s) that are linked to that particular question in the CTA database. Also, for each question answered “Yes” and having additional multiple selection options, return the corresponding Skill Suite(s) that are liked to each particular selected multiple selection option(s).

In operation 2914, the CTA may then pull the unique questions for a second section of questions (“section 2 questions”) presented to the particular end user. In operation 2916, the CTA may then display a “Status Page” that shows all of the Skill Categories and Skill Suites that the User will be answering questions about during Section 2. After the end user answers all of the questions in a given skill suite in the second section of questions and clicks on “Next,” their answers may be written to the database and stored for later calculations (see operations 418 and 2920).

In operation 2922, after the user has competed all of the Section 2 questions, the CTA may then compile all of the data and calculate the results. In operation 2924, each skill that the end user gave answers too is scored based on the calculation (Calculation 2) and the CTA then identifies the top 10 skill based on their score for use in a third section of questions (“section 3 questions”). .

With continuing reference to FIG. 29, in operation 2926, the CTA may then display another “Status Page” that shows the top 10 Skills that the end user will be answering questions about during a third section of the questions presented to the end user (“section 3 questions”). In Section 3, after the user answers all of the questions for a given skill suite and clicks on “Submit,” their answers may be written to the database and stored for later calculations (see operations 2928 and 2930).

In operations 2932 and 2934, after the end user has competed all of the Section 3 questions, CTA may then compile all of the data and calculates the results (Calculation 3). To perform this calculation, the CTA may compile all of the scores for each Skill and return various reports based on the calculated scores. In operation 2936, the end user may be taken to “congratulations, completion screen” from there the end user may advance to view a Personal Learning Plan, a Training hours report and a Course Approval Status Report. In the Personalized Learning Plan Report, the end user may be asked to check the courses they wish to request from their Personal Learning plan (see operation 2938). In operation 2940, the end user's requested courses are stored in the database along with their user ID for reference.

In operation 2942, the CTA may also retrieve the users managers name and email address from the Database. With this information, CTA may sends an auto generated email to the end user's manager prompting the manager to either accept or reject the end user's requested courses (see operation 2944). After being notified, the manager logs in to CTA and views the Personal

Learning Plan of the end user in operation 2946. In operation 2948, the manager approves the some or all of the courses selected by end user and the approved courses are stored in the database. In operation 2950, data from the database may be retrieved by the CTA to generate a course status report.

Calculation 1 in operation 2912 of FIG. 29 may be accomplished as follows. For each “Yes/No” question answered “YES” on the Job Info questionnaire—return the corresponding Skill Suite(s) that are linked to that particular question in the CTA database. Also, for each question answered “Yes” and having additional multiple selection options, return the corresponding Skill Suite(s) that are liked to each particular selected multiple selection option(s).

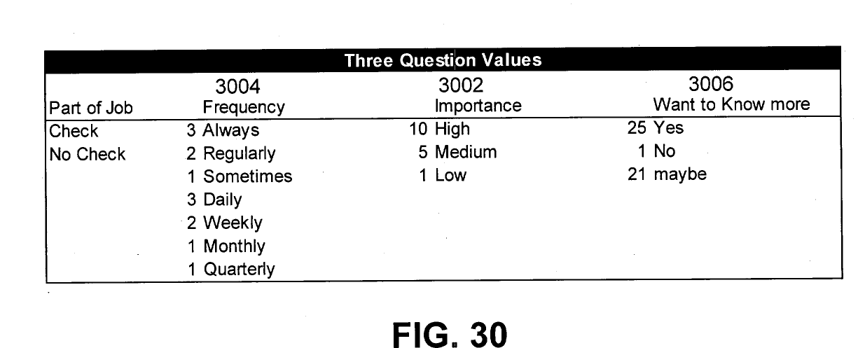

FIG. 30 is a table 3000 of exemplary answer values used by the CTA to score a skill in accordance with an exemplary embodiment of the present invention. These values may be utilized in calculation 2 in operation 2924 of FIG. 29. In calculation 2, the CTA may calculate the score for each of the skills that the user gives answers to in the section 2 question using the point values set forth in the table 3000. As set forth previously, each skill may have three specific drop down answer boxes. The first drop down being “Importance to your Job Role?” (see the header Importance 3002 for the score details). The second drop down being “How often do you Use it?” (see the header Frequency 3004 for the score details). The third drop down being “Would you like to learn more?” (see Want to know more 3004 for the score details). The respective score for each drop down answer box may be written to and stored in the CTA database under each end user's personal CTA user ID.

Calculation 3 in operation 2934 of FIG. 29 may be performed as follows. In section 3, the end user may be presented with the top ten skills that were calculated after completing section 2 and using the values obtained from the second calculation above. For each of the top ten skills, the CTA may pull from the database the corresponding skill objects and then ask two questions for each object under each skill. The first question asks the end user to put a check next to each of the skill objects that are a “Part of you job function”. For each skill object that the user checks associated with this question CTA may give a value of 1 and store the value in the database when the user selects “Submit.” The same occurs for the second question: “Would you like to learn more about it?” Note if the user does not check any of the boxes for either of the skill objects then CTA may assign a negative value of e.g. (a point value of −16) to be added to the entire score for the particular skill. This part of the algorithm may serve as a fail-safe measure to eliminate those particular skills that users may have scored high but realized that the skill objects that further describe the skill and corresponding course for that skill. If none of the skill objects apply then CTA will be sure not to recommend the corresponding course. When the user finishes this section completely and selects the “Calculate” button at the end of the section 3 status page, CTA may calculate the value for each skill throughout CTA based on the following method: First, the CTA may add up all of the stored values for each of the skills for each user (including any of the negative values as described in the previous paragraph.).

After compiling all of the scores, CTA then perform the following functions to develop the following reports. For the personal learning plan report, the CTA may rank all of skills by adding up the scores for each and sorting them in the order of the highest score first and down from there (including any negative values stored during the Section 3 question). For a personalized learning plan, the CTA may identify the top ten ranked skills and pull from the database the corresponding courses that are tied to each of the identified skills. The CTA may then present the personalized learning plan report to the end user. A training hours report may be created by the CTA retrieving course hour data from the database for each of the courses from the personalized learning plan and display it to the end user. A course approval status report may be created by the CTA by retrieving the stored course request data from a specific user or group of users and returning the status of the courses to be approved or rejected by their manager and added or not added to the end user's set of courses.

Reports

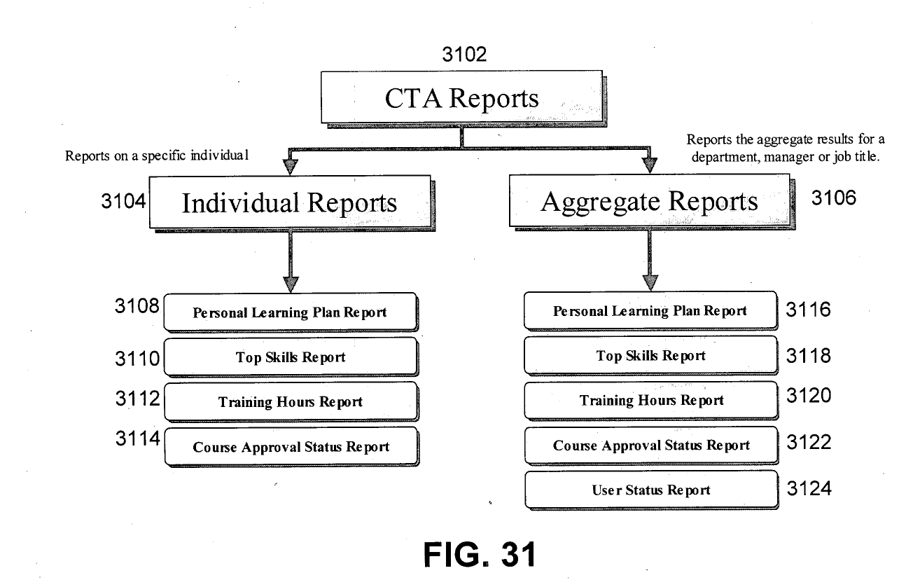

FIG. 31 is a schematic block diagram of reports that may be generated utilizing a career planning and managing application in accordance with an embodiment of the present invention. As previously discussed, the career planning and managing application 3102 may generate both individual reports 3104 and aggregate reports 3106. In accordance with one embodiment, a set of individual reports 3104 that may be generated by the career planning and managing application 3102 may include an individual personal learning plan report 3108, an individual top skills report 3110, an individual training hours report 3112, and an individual course approval status report 3114. A similar set of aggregate reports 3106 may be generated by the career planning and managing application including an aggregate personal learning plan report 3116, an aggregate top skills report 3118, an aggregate training hours report 3120, an aggregate course approval status report 3122; and an aggregate user status report 3124.

Individual Reports

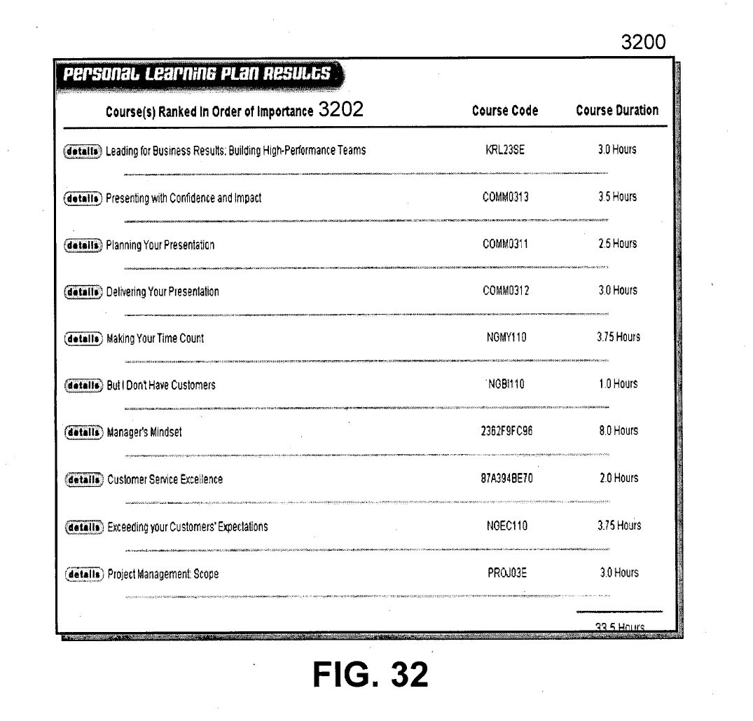

FIG. 32 is a schematic diagram of an exemplary individual personal learning plan report 3200 in accordance with an embodiment of the present invention. An individual personal learning plan report may list the course(s) recommended to the individual end user based on answers he/she provided to the career planning and managing application.

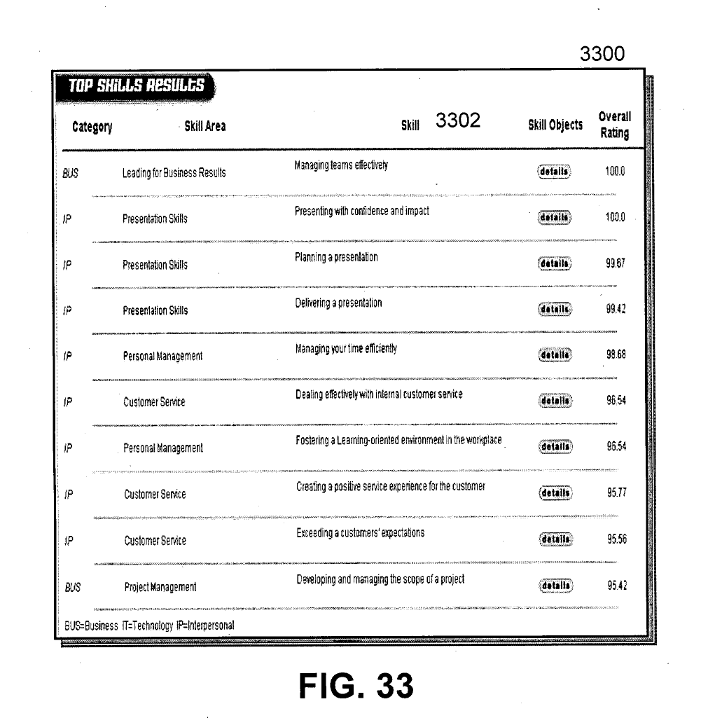

FIG. 33 is a schematic diagram of an exemplary individual top skills report 3300 in accordance with an embodiment of the present invention. An individual top skills report may list the individual end user's top skills 3302 identified based on his/her answers to the career planning and managing application. An individual training hours report may display the individual end user's recommended training hours broken into categories such as technology (IT), business, and interpersonal skills. An individual course approval status report may be generated to show the status of the courses in the approval process.

Aggregate Reports

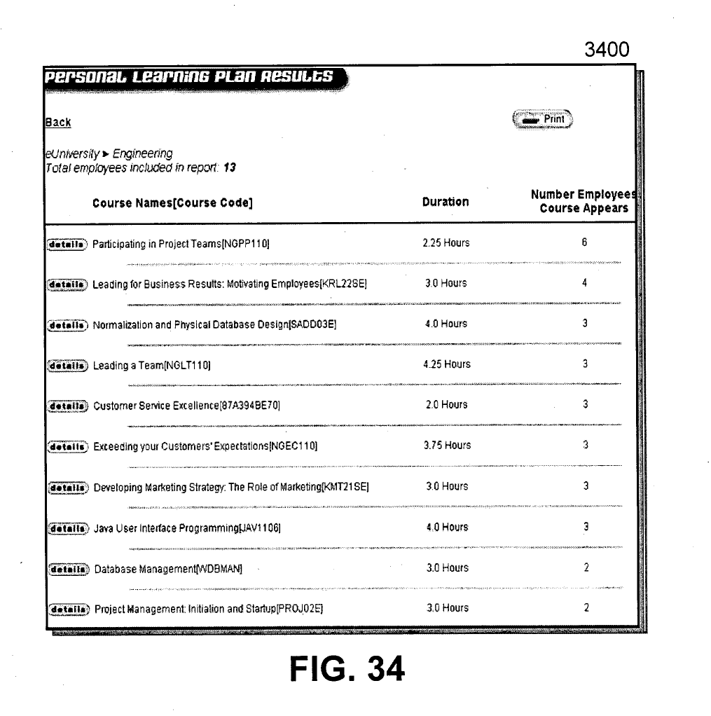

FIG. 34 is a schematic diagram of an exemplary aggregate top personal learning plan report 3400 in accordance with an embodiment of the present invention. An aggregate personal learning plan may list the course(s) 3402 recommended to a set of individual end users, ranked in the order of importance. An end user may view this report by company, department, manager, or job title.

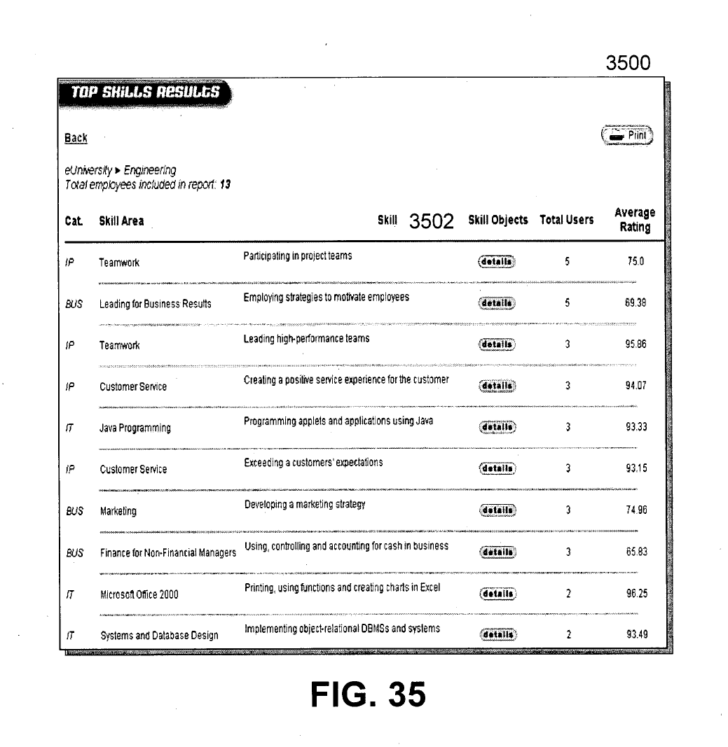

FIG. 35 is a schematic diagram of an exemplary aggregate top skills report 3500 in accordance with an embodiment of the present invention. An aggregate top skills report may list top skills 3502 of a set of individual end users identified by their answers to the career planning and managing application. An end user may view this report by company, department, manager, or job title. An aggregate training hours report may display the average recommended training hours of a set of individual end users based on their personal learning plans. An end user may view the report by company, department, or manager. An aggregate course approval status report shows the status of all courses that have been approved for individual end users. An end user may view this report by company, department, or manager. An aggregate user status report may display whether or not the individual end users have completed their sessions with the career planning and managing application. An end user may view this report by company, department, or manager.

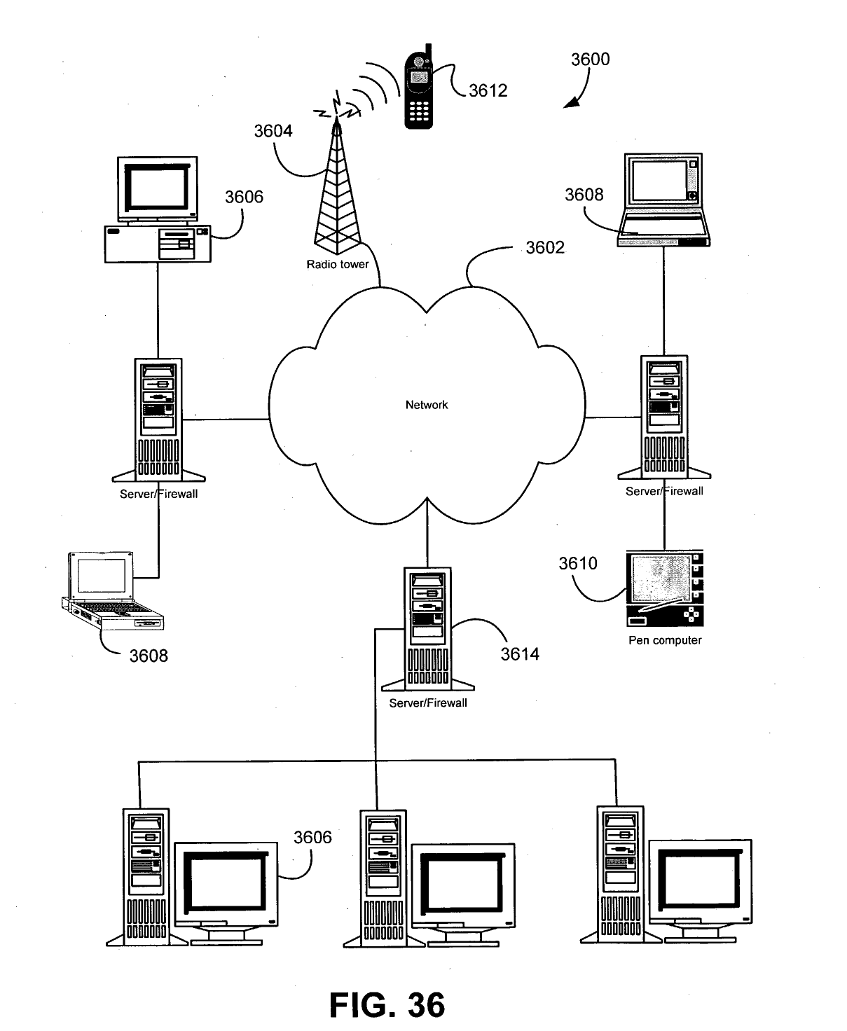

FIG. 36 illustrates an exemplary network system 3600 with a plurality of components 3602 in accordance with one embodiment of the present invention. As shown, such components include a network 3604 which take any form including, but not limited to a local area network, a wide area network such as the Internet, and a wireless network 3605. Coupled to the network 3604 is a plurality of computers which may take the form of desktop computers 3606, lap-top computers 3608, hand-held computers 3610 (including wireless devices 3612 such as wireless PDA's or mobile phones), or any other type of computing hardware/software. As an option, the various computers may be connected to the network 3604 by way of a server 3614 which may be equipped with a firewall for security purposes. It should be noted that any other type of hardware or software may be included in the system and be considered a component thereof.

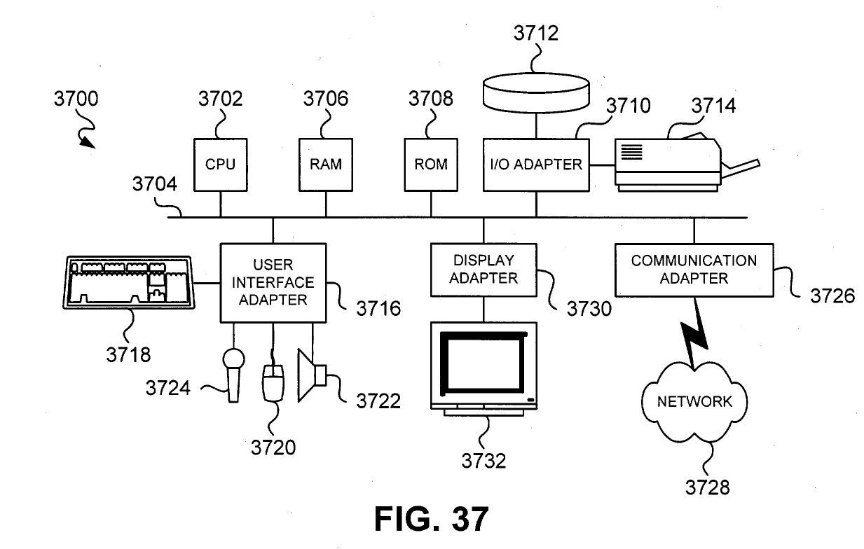

A representative hardware environment associated with the various components of FIG. 36 is depicted in FIG. 37. In the present description, the various sub-components of each of the components may also be considered components of the system. For example, particular software modules executed on any component of the system may also be considered components of the system. In particular, FIG. 37 illustrates an exemplary hardware configuration of a workstation 3700 having a central processing unit 3702, such as a microprocessor, and a number of other units interconnected via a system bus 3704.

The workstation shown in FIG. 37 includes a Random Access Memory (RAM) 3706, Read Only Memory (ROM) 3708, an I/O adapter 3710 for connecting peripheral devices such as, for example, disk storage units 3712 and printers 3714 to the bus 3704, a user interface adapter 3716 for connecting various user interface devices such as, for example, a keyboard 3718, a mouse 3720, a speaker 3722, a microphone 3724, and/or other user interface devices such as a touch screen or a digital camera to the bus 3704, a communication adapter 3726 for connecting the workstation 3700 to a communication network 3728 (e.g., a data processing network) and a display adapter 3730 for connecting the bus 3704 to a display device 3732. The workstation may utilize an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

An embodiment of the present invention may also be written using Java, C, and the C++ language and utilize object oriented programming methodology. Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided.

OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in object-oriented software. Some typical categories are as follows:

Objects can represent physical objects, such as automobiles in a traffic-flow simulation, electrical components in a circuit-design program, countries in an economics model, or aircraft in an air-traffic-control system.

Objects can represent elements of the computer-user environment such as windows, menus or graphics objects.

An object can represent an inventory, such as a personnel file or a table of the latitudes and longitudes of cities.

An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

If 90% of a new OOP software program consists of proven, existing components made from preexisting reusable objects, then only the remaining 10% of the new software project has to be written and tested from scratch. Since 90% already came from an inventory of extensively tested reusable objects, the potential domain from which an error could originate is 10% of the program. As a result, OOP enables software developers to build objects out of other, previously built objects.

This process closely resembles complex machinery being built out of assemblies and sub-assemblies. OOP technology, therefore, makes software engineering more like hardware engineering in that software is built from existing components, which are available to the developer as objects. All this adds up to an improved quality of the software as well as an increased speed of its development.

Programming languages are beginning to fully support the OOP principles, such as encapsulation, inheritance, polymorphism, and composition-relationship. With the advent of the C++language, many commercial software developers have embraced OOP. C++ is an OOP language that offers a fast, machine-executable code. Furthermore, C++ is suitable for both commercial-application and systems-programming projects. For now, C++ appears to be the most popular choice among many OOP programmers, but there is a host of other OOP languages, such as Smalltalk, Common Lisp Object System (CLOS), and Eiffel. Additionally, OOP capabilities are being added to more traditional popular computer programming languages such as Pascal.

The benefits of object classes can be summarized, as follows:

Objects and their corresponding classes break down complex programming problems into many smaller, simpler problems.

Encapsulation enforces data abstraction through the organization of data into small, independent objects that can communicate with each other. Encapsulation protects the data in an object from accidental damage, but allows other objects to interact with that data by calling the object's member functions and structures.

Subclassing and inheritance make it possible to extend and modify objects through deriving new kinds of objects from the standard classes available in the system. Thus, new capabilities are created without having to start from scratch.

Polymorphism and multiple inheritance make it possible for different programmers to mix and match characteristics of many different classes and create specialized objects that can still work with related objects in predictable ways.

Class hierarchies and containment hierarchies provide a flexible mechanism for modeling real-world objects and the relationships among them.

Libraries of reusable classes are useful in many situations, but they also have some limitations. For example:

Complexity. In a complex system, the class hierarchies for related classes can become extremely confusing, with many dozens or even hundreds of classes.

Flow of control. A program written with the aid of class libraries is still responsible for the flow of control (i.e., it must control the interactions among all the objects created from a particular library). The programmer has to decide which functions to call at what times for which kinds of objects.

Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer must still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:

Behavior versus protocol. Class libraries are essentially collections of behaviors that you can call when you want those individual behaviors in your program. A framework, on the other hand, provides not only behavior but also the protocol or set of rules that govern the ways in which behaviors can be combined, including rules for what a programmer is supposed to provide versus what the framework provides.

Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework.

The framework manages the flow of control among its objects. Writing a program involves dividing responsibilities among the various pieces of software that are called by the framework rather than specifying how the different pieces should work together.

Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Thus, through the development of frameworks for solutions to various problems and programming tasks, significant reductions in the design and development effort for software can be achieved. An embodiment of the invention utilizes HyperText Markup Language (HTML) to implement documents on the Internet together with a general-purpose secure communication protocol for a transport medium between the client and the server. HTTP or other protocols could be readily substituted for HTML without undue experimentation. Information on these products is available in T. Berners-Lee, D. Connoly, “RFC 1866: Hypertext Markup Language—2.0” (November 1995); and R. Fielding, H, Frystyk, T. Berners-Lee, J. Gettys and J. C. Mogul, “Hypertext Transfer Protocol—HTTP/1.1: HTTP Working Group Internet Draft” (May 2, 1996). HTML is a simple data format used to create hypertext documents that are portable from one platform to another. HTML documents are SGML documents with generic semantics that are appropriate for representing information from a wide range of domains. HTML has been in use by the World-Wide Web global information initiative since 1990. HTML is an application of ISO Standard 8879; 1986 Information Processing Text and Office Systems; Standard Generalized Markup Language (SGML).

To date, Web development tools have been limited in their ability to create dynamic Web applications which span from client to server and interoperate with existing computing resources. Until recently, HTML has been the dominant technology used in development of Web-based solutions. However, HTML has proven to be inadequate in the following areas:

Poor performance;

Restricted user interface capabilities;

Can only produce static Web pages;

Lack of interoperability with existing applications and data; and

Inability to scale.

Sun Microsystems's Java language solves many of the client-side problems by:

Improving performance on the client side;

Enabling the creation of dynamic, real-time Web applications; and

Providing the ability to create a wide variety of user interface components.

With Java, developers can create robust User Interface (UI) components. Custom “widgets” (e.g., real-time stock tickers, animated icons, etc.) can be created, and client-side performance is improved. Unlike HTML, Java supports the notion of client-side validation, offloading appropriate processing onto the client for improved performance. Dynamic, real-time Web pages can be created. Using the above-mentioned custom UI components, dynamic Web pages can also be created. Sun's Java language has emerged as an industry-recognized language for “programming the Internet.” Sun defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.”

JavaScript is an interpreted programming or script language from Netscape. It is somewhat similar in capability to Microsoft's Visual Basic, Sun's Tcl, the UNIX-derived Perl, and IBM's REX. In general, script languages are easier and faster to code in than the more structured and compiled languages such as C and C++. JavaScript is used in Web site development to do such things as: automatically change a formatted date on a Web page; cause a linked-to page to appear in a popup window; and cause text or a graphic image to change during a mouse rollover.

JavaScript uses some of the same ideas found in Java. JavaScript code can be imbedded in HTML pages and interpreted by the Web browser (or client). JavaScript can also be run at the server as in Microsoft's Active Server Pages before the page is sent to the requestor. Both Microsoft and Netscape browsers support JavaScript.

Another technology that provides similar function to Java is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for Java without undue experimentation to practice the invention.

A technology of Active X is the component object model (COM). Used in a network with a directory and additional support, COM becomes the distributed component object model (DCOM). The main thing that you create when writing a program to run in the ActiveX environment is a component, a self-sufficient program that can be run anywhere in your ActiveX network. This component is known as an ActiveX control. ActiveX is Microsoft's answer to the Java technology from Sun Microsystems. An ActiveX control is roughly equivalent to a Java applet.

OCX stands for “Object Linking and Embedding control.” Object Linking and Embedding (OLE) was Microsoft's program technology for supporting compound documents such as the Windows desktop. The Component Object Model now takes in OLE as part of a larger concept. Microsoft now uses the term “ActiveX control” instead of “OCX” for the component object.

An advantage of a component is that it can be re-used by many applications (referred to as component containers). A COM component object (ActiveX control) can be created using one of several languages or development tools, including C++ and Visual Basic, or PowerBuilder, or with scripting tools such as VBScript.

Transmission Control Protocol/Internet Protocol (TCP/IP) is a basic communication language or protocol of the Internet. It can also be used as a communications protocol in the private networks called intranet and in extranet. When you are set up with direct access to the Internet, your computer is provided with a copy of the TCP/IP program just as every other computer that you may send messages to or get information from also has a copy of TCP/IP.

TCP/IP is a two-layering program. The higher layer, Transmission Control Protocol (TCP), manages the assembling of a message or file into smaller packet that are transmitted over the Internet and received by a TCP layer that reassembles the packets into the original message. The lower layer, Internet Protocol (IP), handles the address part of each packet so that it gets to the right destination. Each gateway computer on the network checks this address to see where to forward the message. Even though some packets from the same message are routed differently than others, they'll be reassembled at the destination.

TCP/IP uses a client/server model of communication in which a computer user (a client) requests and is provided a service (such as sending a Web page) by another computer (a server) in the network. TCP/IP communication is primarily point-to-point, meaning each communication is from one point (or host computer) in the network to another point or host computer. TCP/IP and the higher-level applications that use it are collectively said to be “stateless” because each client request is considered a new request unrelated to any previous one (unlike ordinary phone conversations that require a dedicated connection for the call duration). Being stateless frees network paths so that everyone can use them continuously. (Note that the TCP layer itself is not stateless as far as any one message is concerned. Its connection remains in place until all packets in a message have been received.).

Many Internet users are familiar with the even higher layer application protocols that use TCP/IP to get to the Internet. These include the World Wide Web's Hypertext Transfer Protocol (HTTP), the File Transfer Protocol (FTP), Telnet which lets you logon to remote computers, and the Simple Mail Transfer Protocol (SMTP). These and other protocols are often packaged together with TCP/IP as a “suite.”

Personal computer users usually get to the Internet through the Serial Line Internet Protocol (SLIP) or the Point-to-Point Protocol. These protocols encapsulate the IP packets so that they can be sent over a dial-up phone connection to an access provider's modem.

Protocols related to TCP/IP include the User Datagram Protocol (UDP), which is used instead of TCP for special purposes. Other protocols are used by network host computers for exchanging router information. These include the Internet Control Message Protocol (ICMP), the Interior Gateway Protocol (IGP), the Exterior Gateway Protocol (EGP), and the Border Gateway Protocol (BGP).

Internetwork Packet Exchange (IPX)is a networking protocol from Novell that interconnects networks that use Novell's NetWare clients and servers. IPX is a datagram or packet protocol. IPX works at the network layer of communication protocols and is connectionless (that is, it doesn't require that a connection be maintained during an exchange of packets as, for example, a regular voice phone call does).

Packet acknowledgment is managed by another Novell protocol, the Sequenced Packet Exchange (SPX). Other related Novell NetWare protocols are: the Routing Information Protocol (RIP), the Service Advertising Protocol (SAP), and the NetWare Link Services Protocol (NLSP).

A virtual private network (VPN) is a private data network that makes use of the public telecommunication infrastructure, maintaining privacy through the use of a tunneling protocol and security procedures. A virtual private network can be contrasted with a system of owned or leased lines that can only be used by one company. The idea of the VPN is to give the company the same capabilities at much lower cost by using the shared public infrastructure rather than a private one. Phone companies have provided secure shared resources for voice messages. A virtual private network makes it possible to have the same secure sharing of public resources for data.

Using a virtual private network involves encryption data before sending it through the public network and decrypting it at the receiving end. An additional level of security involves encrypting not only the data but also the originating and receiving network addresses. Microsoft, 3Com, and several other companies have developed the Point-to-Point Tunneling Protocol (PPP) and Microsoft has extended Windows NT to support it. VPN software is typically installed as part of a company's firewall server.

Wireless refers to a communications, monitoring, or control system in which electromagnetic radiation spectrum or acoustic waves carry a signal through atmospheric space rather than along a wire. In most wireless systems, radio frequency (RF) or infrared transmission (IR) waves are used. Some monitoring devices, such as intrusion alarms, employ acoustic waves at frequencies above the range of human hearing.

Early experimenters in electromagnetic physics dreamed of building a so-called wireless telegraph. The first wireless telegraph transmitters went on the air in the early years of the 20th century. Later, as amplitude modulation (AM) made it possible to transmit voices and music via wireless, the medium came to be called radio. With the advent of television, fax, data communication, and the effective use of a larger portion of the electromagnetic spectrum, the original term has been brought to life again.

Common examples of wireless equipment in use today include the Global Positioning System, cellular telephone phones and pagers, cordless computer accessories (for example, the cordless mouse), home-entertainment-system control boxes, remote garage-door openers, two-way radios, and baby monitors. An increasing number of companies and organizations are using wireless LAN. Wireless transceivers are available for connection to portable and notebook computers, allowing Internet access in selected cities without the need to locate a telephone jack. Eventually, it will be possible to link any computer to the Internet via satellite, no matter where in the world the computer might be located.

Bluetooth is a computing and telecommunications industry specification that describes how mobile phones, computers, and personal digital assistants (PDA's) can easily interconnect with each other and with home and business phones and computers using a short-range wireless connection. Each device is equipped with a microchip transceiver that transmits and receives in a previously unused frequency band of 2.45 GHz that is available globally (with some variation of bandwidth in different countries). In addition to data, up to three voice channels are available. Each device has a unique 48-bit address from the IEEE 802 standard. Connections can be point-to-point or multipoint. The maximum range is 10 meters. Data can be presently be exchanged at a rate of 1 megabit per second (up to 2 Mbps in the second generation of the technology). A frequency hop scheme allows devices to communicate even in areas with a great deal of electromagnetic interference. Built-in encryption and verification is provided.

Encryption is the conversion of data into a form, called a ciphertext, that cannot be easily understood by unauthorized people. Decryption is the process of converting encrypted data back into its original form, so it can be understood.

The use of encryption/decryption is as old as the art of communication. In wartime, a cipher, often incorrectly called a “code,” can be employed to keep the enemy from obtaining the contents of transmissions (technically, a code is a means of representing a signal without the intent of keeping it secret; examples are Morse code and ASCII). Simple ciphers include the substitution of letters for numbers, the rotation of letters in the alphabet, and the “scrambling” of voice signals by inverting the sideband frequencies. More complex ciphers work according to sophisticated computer algorithm that rearrange the data bits in digital signals.

In order to easily recover the contents of an encrypted signal, the correct decryption key is required. The key is an algorithm that “undoes” the work of the encryption algorithm.

Alternatively, a computer can be used in an attempt to “break” the cipher. The more complex the encryption algorithm, the more difficult it becomes to eavesdrop on the communications without access to the key.

Rivest-Shamir-Adleman (RSA) is an Internet encryption and authentication system that uses an algorithm developed in 1977 by Ron Rivest, Adi Shamir, and Leonard Adleman. The RSA algorithm is a commonly used encryption and authentication algorithm and is included as part of the Web browser from Netscape and Microsoft. It's also part of Lotus Notes, Intuit's Quicken, and many other products. The encryption system is owned by RSA Security.

The RSA algorithm involves multiplying two large prime numbers (a prime number is a number divisible only by that number and 1) and through additional operations deriving a set of two numbers that constitutes the public key and another set that is the private key. Once the keys have been developed, the original prime numbers are no longer important and can be discarded. Both the public and the private keys are needed for encryption/decryption but only the owner of a private key ever needs to know it. Using the RSA system, the private key never needs to be sent across the Internet.

The private key may be used to decrypt text that has been encrypted with the public key. For example, to send a message to a recipient, a sender first obtains the recipient's public key (but not the recipient's private key) from a central administrator and encrypt the message using the recipient's public key. When the recipient receives the encrypted message from the sender, the recipient may then decrypt the encrypted message with the recipient's private key. In addition to encrypting messages (which ensures privacy), senders may also authenticate themselves to recipients (so that the recipient can verify the identity of the sender) by using the sender's own private key to encrypt a digital certificate. When the recipient receives the digital certificate, the recipient can use the sender's public key to decrypt it.

A pop-up is a graphical user interface (GUI) display area, usually a small window, that suddenly appears (“pops up”) in the foreground of the visual interface. Pop-ups can be initiated by a single or double mouse click or rollover (sometimes called a mouseover), and also possibly by voice command or can simply be timed to occur. A pop-up window is usually smaller than the background window or interface; otherwise, it is may be called a replacement interface.

On the World Wide Web, JavaScript (and less commonly Java applets) may be used to create interactive effects including pop-up and full overlay windows. A menu or taskbar pulldown can be considered a form of pop-up. So can the little message box you get when you move your mouse over taskbars in many PC applications.

Plug-in applications are programs that can easily be installed and used as part of your Web browser. Initially, the Netscape browser allowed you to download, install, and define supplementary programs that played sound or motion video or performed other functions. These were called helper applications. However, these applications run as a separate application and require that a second window be opened. A plug-in application is recognized automatically by the browser and its function is integrated into the main HTML file that is being presented.

Plug-in applications are programs that can easily be installed and used as part of your Web browser. Initially, the Netscape browser allowed you to download, install, and define supplementary programs that played sound or motion video or performed other functions. These were called helper applications. However, these applications run as a separate application and require that a second window be opened. A plug-in application is recognized automatically by the browser and its function is integrated into the main HTML file that is being presented.

A browser is an application program that provides a way to look at and interact with all the information on the World Wide Web. The word “browser” seems to have originated prior to the Web as a generic term for user interfaces that let you browse (navigate through and read) text files online. By the time the first Web browser with a GUI was generally available (Mosaic, in 1993), the term seemed to apply to Web content, too. Technically, a Web browser may be considered a client program that uses the Hypertext Transfer Protocol (HTTP) to make requests of Web servers throughout the Internet on behalf of the browser user. Many of the user interface features in Mosaic, however, went into the first widely-used browser, Netscape Navigator. Microsoft followed with its Microsoft Internet Explorer. Lynx is a text-only browser for UNIX shell and VMS users. Another browser is Opera. While some browsers also support e-mail (indirectly through e-mail Web sites) and the File Transfer Protocol (FTP), a Web browser may not be required for those Internet protocols and more specialized client programs are more popular.

Hashing is the transformation of a string of characters into a usually shorter fixed-length value or key that represents the original string. Hashing may be used to index and retrieve items in a database because it is faster to find the item using the shorter hashed key than to find it using the original value. It may also used in encryption algorithms. A hashing algorithm is called the hash function. Hashing may also used to encrypt and decrypt digital signatures (used to authenticate message senders and receivers). The digital signature is transformed with the hash function and then both the hashed value (known as a message-digest) and the signature are sent in separate transmissions to the receiver. Using the same hash function as the sender, the receiver derives a message-digest from the signature and compares it with the message-digest it also received. They should be the same. The hash function may be used to index the original value or key and then used later each time the data associated with the value or key is to be retrieved. Thus, hashing is always a one-way operation. There's no need to “reverse engineer” the hash function by analyzing the hashed values. In fact, the ideal hash function can't be derived by such analysis. A good hash function also should not produce the same hash value from two different inputs. If it does, this is known as a collision. A hash function that offers an extremely low risk of collision may be considered acceptable. Some exemplary hash functions include the division-remainder method, the folding method, the radix transformation method and the digit rearrangement method. In the division-remainder method, the size of the number of items in the table is estimated. That number is then used as a divisor into each original value or key to extract a quotient and a remainder. The remainder is the hashed value. The folding method divides the original value into several parts, adds the parts together, and then uses the last four digits (or some other arbitrary number of digits) as the hashed value or key. The radix transformation method may be utilized where the value or key is digital. In this method, the number base (or radix) can be changed resulting in a different sequence of digits. For example, a decimal numbered key could be transformed into a hexadecimal numbered key. High-order digits can be discarded to fit a hash value of uniform length. The digit rearrangement method is simply the taking of part of the original value or key such as digits in positions 3 through 6, reversing their order, and then using that sequence of digits as the hash value or key.

A hash function that works well for database storage and retrieval might not work as for cryptographic or error-checking purposes. There are several well-known hash functions used in cryptography. These include the message-digest hash functions MD2, MD4, and MD5, used for hashing digital signatures into a shorter value called a message-digest, and the Secure Hash Algorithm (SHA), a standard algorithm, that makes a larger (60-bit) message digest and is similar to MD4.

U.S. Pat. No. 4,309,569 issued Jan. 5, 1982 to Ralph Merkle and entitled, “Method of providing digital signatures” and incorporated herein by reference describes a use of hash functions to build trees in order to authenticate an item in a list of items.

A timestamp may be an identifier for transaction that may be used to permit ordering. A timestamp may also be used to verify digital signatures and help reduce the possibility that someone will derive a private key from the public key in a digital certificate. In order to reduce the possibility that someone will derive a private key from the public key in a digital certificate, the certifying authority may issue the key pair with an expiration date so that they must be replaced periodically. Any signature applied after the digital certificate expires is invalid. To assure that a signature was applied before the certificate expired, the certifying authority can timestamp a digital signature. Essentially, that means taking the signature, adding the current time and signing them together. When a digital signature is timestamped in this way, the software can verify that the signature was applied while the certificate was still valid. U.S. Pat. No. 5,136,647 issued to S. A. Haber et al. on Aug. 4, 1992, entitled “Method for secure timestamping of digital documents” is incorporated herein by reference and discloses a variety of technological and algorithmic components of digital timestamping including the linking of timestamp requests in a sequence, a random-witness method that uses the document being timestamped to pseudo-randomly choose timestamping witnesses, the use of a single hash value to represent a timestamp request for an accumulation or collection of digital documents, and a time-stamping process that does not explicitly require the use of a digital signature.

The Secure Sockets Layer (SSL) is a commonly-used protocol for managing the security of a message transmission on the Internet. SSL has recently been succeeded by Transport Layer Security (TLS), which is based on SSL. SSL uses a program layer located between the Internet's Hypertext Transfer Protocol (HTTP) and Transport Control Protocol (TCP) layers. SSL is included as part of both the Microsoft and Netscape browsers and most Web server products. Developed by Netscape, SSL also gained the support of Microsoft and other Internet client/server developers as well and became the de facto standard until evolving into Transport Layer Security. The “sockets” part of the term refers to the sockets method of passing data back and forth between a client and a server program in a network or between program layers in the same computer. SSL uses the public-and-private key encryption system from RSA, which also includes the use of a digital certificate.

TLS and SSL are an integral part of most Web browsers (clients) and Web servers. If a Web site is on a server that supports SSL, SSL can be enabled and specific Web pages can be identified as requiring SSL access. Any Web server can be enabled by using Netscape's SSLRef program library which can be downloaded for noncommercial use or licensed for commercial use. TLS and SSL are not interoperable. However, a message sent with TLS can be handled by a client that handles SSL but not TLS.

A SSL protocol is described in the SSL Protocol Version 3.0 by the Transport Layer Security Working Group, Nov. 18, 1996 for providing communications privacy over the Internet and allowing client/server applications to communicate in a way that is designed to prevent eavesdropping, tampering, or message forgery, the disclosure of which is incorporated herein by reference in its entirety.

Transport Layer Security (TLS) is a protocol that ensures privacy between communicating applications and their users on the Internet. When a server and client communicate, TLS ensures that no third party may eavesdrop or tamper with any message. TLS is a successor to the Secure Sockets Layer (SSL). TLS is composed of two layers: the TLS Record Protocol and the TLS Handshake Protocol. The TLS Record Protocol provides connection security with some encryption method such as the Data Encryption Standard (DES). The TLS Record Protocol can also be used without encryption. The TLS Handshake Protocol allows the server and client to authenticate each other and to negotiate an encryption algorithm and cryptographic keys before data is exchanged. The TLS protocol is based on Netscape's SSL 3.0 protocol; however, TLS and SSL are not interoperable. The TLS protocol does contain a mechanism that allows TLS implementation to back down to SSL 3.0. A TLS protocol is described in the document entitled, “The TLS Protocol, Version 1” by the Network Working Group of the Internet Society, 1999, the disclosure of which is incorporated herein by reference in its entirety. This document specifies Version 1.0 of the Transport Layer Security (TLS) protocol. The TLS protocol provides communications privacy over the Internet. The protocol allows client/server applications to communicate in a way that is designed to prevent eavesdropping, tampering, or message forgery.

Wireless Transport Layer Security (WTLS) is the security level for Wireless Application Protocol (WAP) applications. Based on Transport Layer Security (TLS) v1.0 (a security layer used in the Internet, equivalent to Secure Socket Layer 3.1), WTLS was developed to address the problematic issues surrounding mobile network devices—such as limited processing power and memory capacity, and low bandwidth—and to provide adequate authentication, data integrity, and privacy protection mechanisms.

Wireless transactions, such as those between a user and their bank, require stringent authentication and encryption to ensure security to protect the communication from attack during data transmission. Because mobile networks do not provide end-to-end security, TLS had to be modified to address the special needs of wireless users. Designed to support datagrams in a high latency, low bandwidth environment, WTLS provides an optimized handshake through dynamic key refreshing, which allows encryption keys to be regularly updated during a secure session.

The Wired Equivalent Privacy (WEP) algorithm, is part of the 802.11 standard. The 802.11 standard describes the communication that occurs in wireless local area networks (LANs). The Wired Equivalent Privacy (WEP) algorithm is used to protect wireless communication from eavesdropping. A secondary function of WEP is to prevent unauthorized access to a wireless network; this function is not an explicit goal in the 802.11 standard, but it is frequently considered to be a feature of WEP. WEP relies on a secret key that is shared between a mobile station (e.g. a laptop with a wireless Ethernet card) and an access point (i.e. a base station). The secret key is used to encrypt packets before they are transmitted, and an integrity check is used to ensure that packets are not modified in transit. The standard does not discuss how the shared key is established. In practice, most installations use a single key that is shared between all mobile stations and access points.

Based on the foregoing specification, the invention may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware to create a computer system or computer sub-system embodying the method of the invention.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed is:

1. A method for generating a customized course curriculum, comprising:
a) presenting a plurality of questions to an end user, wherein answers to the questions received from the end user are analyzed to identify one or more skills and to rank the identified skills, wherein each skill has one or more courses associated therewith;
b) generating a list of the courses associated with the identified skills, wherein the courses are ordered in the list based on the ranking of associated identified skills; and
c) presenting the list of courses to the end user.

2. The method of claim 1, wherein the presenting of the plurality of questions to the end user includes presenting a set of generalized questions to the end user, and wherein answers by the end user to the set of generalized questions are analyzed to identify sets of skills to the end user.

3. The method of claim 2, wherein each of the identified sets of skills is associated with a category of skills, and wherein the identified sets of skills are presented to the end user based on the associated category of skills.

4. The method of claim 2, wherein the end user is presented with a plurality of questions relating to the skills in the identified sets of skills to identify skills to the end user in the identified sets of skills and to estimate a degree of relevance to the end user for each identified skill.

5. The method of claim 4, wherein for each identified set of skills, the end user is presented with a list of the skills in the set of skills and is queried to identify which of the skills in the set of skills are of relevance to the end user.

6. The method of claim 4, wherein for each identified skill, the questions presented to the end user include: a query about the importance of the skill to the end user, a query about the frequency the end user uses the skill, and a query about whether the end user is interested in learning more about the identified skill.

7. The method of claim 6, wherein for each identified skill, the analysis of the answers to the questions received from the end user includes: assigning a value to the answer to each query, and calculating a total value for the identified skill from the sum of assigned values of the queries presented to the end user about the identified skill, and wherein the identified skills are ranked with respect to one another based on the total point values of the identified skills.

8. The method of claim 4, wherein for each identified skill, the end user is presented with a plurality of questions relating to one or more aspects of the identified skill to estimate a degree of relevance to the end user for each identified skill.

9. The method of claim 8, wherein for each aspect of the identified skill, the questions presented to the end user include: a query about the importance of the aspect of the identified skill to the end user, and a query about whether the end user is interested in learning more about the aspect of the identified skill.

10. The method of claim 9, wherein the analysis of the answers to the questions received from the end user includes: for each aspect of the identified skill, assigning a value to the aspect based on the answers by the end user to the two queries for the aspect, and calculating an total aspect value for the identified skill based on the sum of the assigned values of the aspects for the identified skill, and adding the total aspect value to a total point value of the identified skill, and wherein the identified skills are ranked in part with respect to one another based on the total values of the identified skills.

11. The method of claim 4, further comprising providing information about one or more aspects of a skill during the presenting of the plurality of questions relating to the skills in the identified sets of skills.

12. The method of claim 1, further comprising tracking the progress of the end user answering the presented questions, and generating a status report indicating the progress of the end user in answering the presented questions.

13. The method of claim 1, further comprising providing information about one or more aspects of a skill during the presenting of the plurality of questions to the end user.

14. The method of claim 1, further comprising permitting the end user to selectively obtain information about at least one of the courses from the list of courses.

15. The method of claim 1, wherein each course has associated therewith a duration of time for completing the course, and wherein information about the duration of time for completing the course is presented to the end user with the list of courses.

16. The method of claim 1, further comprising permitting the end user to select courses from the list of courses.

17. The method of claim 16, further comprising presenting at least one of the selected courses to the end user.

18. The method of claim 17, further comprising monitoring the progress of the end user in completing the presented course, and generating a report about the progress of the end user in completing the present course based on the monitoring.

19. The method of claim 16, further comprising presenting a list of the courses selected by the end user to an authorized second end user, and permitting the second end user to at least one of: approve one or more of the selected courses, and add one or more additional courses to the list of selected courses.

20. The method of claim 1, wherein the courses include teachings relating to the identified skills.

21. The method of claim 1, further comprising analyzing at least one of the courses to identify skills associated with subject matter of the course, and generating one or more questions relating to the skills identified in the one or more courses, and wherein the plurality of questions presented to the end user include the generated questions.

22. A system for generating a customized course curriculum, comprising:
a computer hosting an application and being in communication with an end user via a network;
a database coupled to the computer and storing therein a plurality of questions, a plurality of skills, and a plurality of courses, wherein each skill is associated with at least one of the questions and at least one of the courses;
the application retrieving questions from the database and presenting the retrieved questions to the end user via the network,
the application receiving via the network answers to the questions from the end user;
the application analyzing the received answers to the questions to identify one or more skills associated with the answered questions and rank the identified skills;
the application generating a list of the courses associated with the identified skills, wherein the courses are ordered in the list based on the ranking of associated identified skills; and
the application presenting the list of courses to the end user via the network.

23. The system of claim 22, wherein the presenting of the questions to the end user includes presenting a set of generalized questions to the end user, and wherein answers by the end user to the set of generalized questions are analyzed to identify sets of skills to the end user.

24. The system of claim 23, wherein each of the identified sets of skills is associated with a category of skills, and wherein the identified sets of skills are presented to the end user based on the associated category of skills.

25. The system of claim 23, wherein the end user is presented with a plurality of questions relating to the skills in the identified sets of skills to identify skills to the end user in the identified sets of skills and to estimate a degree of relevance to the end user for each identified skill.

26. The system of claim 25, wherein for each identified set of skills, the end user is presented with a list of the skills in the set of skills and is queried to identify which of the skills in the set of skills are of relevance to the end user.

27. The system of claim 25, wherein for each identified skill, the questions presented to the end user include: a query about the importance of the skill to the end user, a query about the frequency the end user uses the skill, and a query about whether the end user is interested in learning more about the identified skill.

28. The system of claim 27, wherein for each identified skill, the analysis of the answers to the questions received from the end user includes: assigning a value to the answer to each query, and calculating a total value for the identified skill from the sum of assigned values of the queries presented to the end user about the identified skill, and wherein the identified skills are ranked with respect to one another based on the total point values of the identified skills.

29. The system of claim 25, wherein for each identified skill, the end user is presented with a plurality of questions relating to one or more aspects of the identified skill to estimate a degree of relevance to the end user for each identified skill.

30. The system of claim 29, wherein for each aspect of the identified skill, the questions presented to the end user include: a query about the importance of the aspect of the identified skill to the end user, and a query about whether the end user is interested in learning more about the aspect of the identified skill.

31. The system of claim 30, wherein the analysis of the answers to the questions received from the end user includes: for each aspect of the identified skill, assigning a value to the aspect based on the answers by the end user to the two queries for the aspect, and calculating an total aspect value for the identified skill based on the sum of the assigned values of the aspects for the identified skill, and adding the total aspect value to a total point value of the identified skill, and wherein the identified skills are ranked in part with respect to one another based on the total values of the identified skills.

32. The system of claim 25, wherein the application provides information about one or more aspects of a skill during the presentation of the questions relating to the skills in the identified sets of skills.

33. The system of claim 22, wherein the application tracks the progress of the end user answering the presented questions, and generates a status report indicating the progress of the end user in answering the presented questions.

34. The system of claim 22, wherein the application provides information about one or more aspects of a skill during the presenting of questions to the end user.

35. The system of claim 22, wherein the application permits the end user to selectively obtain information about at least one of the courses from the list of courses.

36. The system of claim 22, wherein each course has associated therewith a duration of time for completing the course, and wherein the application presents information about the duration of time for completing the course to the end user with the list of courses.

37. The system of claim 22, wherein the application permits the end user to select courses from the list of courses.

38. The system of claim 37, further comprising the application presenting at least one of the selected courses to the end user via the network.

39. The system of claim 38, further comprising the application monitoring the progress of the end user in completing the presented course, and generating a report about the progress of the end user in completing the present course based on the monitoring.

40. The system of claim 37, further comprising the application presenting a list of the courses selected by the end user to an authorized second end user via the network, and permitting the second end user to at least one of: approve one or more of the selected courses, and add one or more additional courses to the list of selected courses.

41. The system of claim 22, wherein the courses include teachings relating to the identified skills.

42. The system of claim 22, wherein the application analyzes at least one of the courses to identify skills associated with subject matter of the course and generates one or more questions relating to the identified skills, and wherein the plurality of questions presented to the end user include the generated questions.

43. A computer program product for generating a customized course curriculum, comprising:
a) computer code for presenting a plurality of questions to an end user, wherein answers to the questions received from the end user are analyzed to identify one or more skills and to rank the identified skills, wherein each skill has one or more courses associated therewith;
b) computer code for generating a list of the courses associated with the identified skills, wherein the courses are ordered in the list based on the ranking of associated identified skills; and
c) computer code for presenting the list of courses to the end user.

44. A system for generating a customized course curriculum, comprising:
a) logic for presenting a plurality of questions to an end user, wherein answers to the questions received from the end user are analyzed to identify one or more skills and to rank the identified skills, wherein each skill has one or more courses associated therewith;
b) logic for generating a list of the courses associated with the identified skills, wherein the courses are ordered in the list based on the ranking of associated identified skills; and
c) logic for presenting the list of courses to the end user.
